(19) United States
(12) Patent Application Publication
(10) Pub. No.: US 2026/0288860 A1
(43) Pub. Date: Sep. 24, 2026

(54) SYSTEM

(71) Applicant: SoftBank Group Corp., Tokyo (JP)

(72) Inventor: Tsukasa SEKITA, Tokyo (JP)

(73) Assignee: SoftBank Group Corp., Tokyo (JP)

(21) Appl. No.: 19/561,682

(22) Filed: Mar. 10, 2026

(30) Foreign Application Priority Data
Mar. 19, 2025 (JP) 2025-044479

(51) Int. Cl. G06F 16/583; G06N 3/0464; G06N 3/0475

(52) U.S. Cl. CPC G06F 16/583; G06N 3/0464; G06N 3/0475

(57) ABSTRACT

A system includes a processor that is configured to extract visual features from an image or a video, generate a prompt sentence that instructs a search of an information set based on the extracted visual features, and search the information set by using a generative AI model and generate an information list having high relevance.

### CROSS-REFERENCE TO RELATED APPLICATION

This application is based on and claims priority under 35 USC 119 from Japanese Patent Application No. 2025-044479 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional recommendation and retrieval systems that operate on images or videos typically rely on direct similarity matching between low-level visual features and pre-annotated content or on fixed rule-based mappings. Such systems often struggle to capture the semantic intent, mood, or contextual meaning implied by an image or a video, and therefore fail to generate information lists that are perceived as highly relevant by a user. In addition, while generative AI models have recently been used for text-based search and recommendation, there remains a difficulty in effectively bridging visual inputs with generative models in a way that produces high-quality, contextually appropriate prompts and search queries. Furthermore, existing systems frequently do not exploit user-specific preference data in conjunction with visual context to dynamically customize and refine generated information lists. Accordingly, there is a need for a system that can extract visual features from images or videos, automatically generate prompt sentences suitable for use with a generative AI model, and search and customize information lists with high relevance to both the visual content and the user's past preferences.

### SUMMARY

In order to solve the above-described problems, the present invention provides a system comprising a processor, wherein the processor is configured to extract visual features from an image or a video, generate a prompt sentence that instructs a search of an information set based on the extracted visual features, and search the information set by using a generative AI model to generate an information list having high relevance. The processor is further configured to generate a prompt sentence that customizes the information list by taking into account past preference data of a user, and to customize the information list by using the generative AI model. The processor is also configured to present the customized information list to the user via a user interface. By integrating visual feature extraction, prompt generation tailored for a generative AI model, and user preference-based customization, the system enables the automatic generation and presentation of information lists that are more semantically aligned with the visual input and better matched to the individual user's tastes, thereby addressing the limitations of conventional image-and video-based recommendation systems.

The term “processor” refers to one or more hardware elements, such as a central processing unit (CPU), graphics processing unit (GPU), digital signal processor (DSP), or specialized accelerator, and may further include associated memory and control circuitry configured to execute instructions for performing the functions described in the present specification.

The term “visual features” refers to quantitative or qualitative characteristics derived from an image or a video, including but not limited to color distributions, textures, shapes, detected objects, scenes, and spatial relationships between visual elements.

The term “image” refers to a still visual representation, such as a photograph, a frame captured from a camera, or a bitmap or vector graphic, regardless of format, resolution, or color depth.

The term “video” refers to a time-sequenced collection of images, optionally including audio, representing moving visual content, regardless of encoding format, frame rate, or resolution.

The term “information set” refers to a collection of data items or content items that can be searched or retrieved, such as documents, webpages, songs, movies, metadata records, or other digital resources maintained in one or more databases or storage systems.

The term “prompt sentence” refers to a text string, natural language expression, structured query, or combination thereof, that is generated by the processor and provided as input to a generative AI model in order to instruct the model to perform a search, retrieval, or customization operation on the information set.

The term “generative AI model” refers to a machine learning model, such as a large language model, multimodal model, or other neural network-based model, that is capable of generating outputs including text, structured data, or control signals in response to input prompts, and that can be used to search, filter, rank, or customize items in an information set.

The term “information list” refers to an ordered or unordered collection of one or more information items selected from the information set, where each item may include an identifier, title, metadata, or other attributes, and where the list is generated or refined by the processor based on outputs of the generative AI model.

The term “high relevance” refers to a degree of correspondence, similarity, or suitability between an item in the information list and one or more conditions, such as the extracted visual features, the semantic content inferred from the image or video, or the user's preferences, such that the item is evaluated by the system as being more appropriate than items not included in the information list.

The term “past preference data” refers to data indicative of a user's historical selections, interactions, ratings, behaviors, or other feedback regarding items in the information set or similar content, which can be used to model the user's tastes or interests.

The term “customize the information list” refers to modifying, reordering, filtering, augmenting, or otherwise adjusting an information list by the processor so that the resulting list better reflects the past preference data of the user and optionally the context indicated by the visual features.

The term “user interface” refers to any software or hardware mechanism through which information is presented to a user and through which the user can provide input, including but not limited to graphical user interfaces on displays, web pages, mobile applications, touchscreens, voice interfaces, or other interactive presentation means.

The term “present the customized information list to the user” refers to causing the customized information list, or a representation thereof, to be output via the user interface in a form perceivable by the user, such as visually on a display or audibly via a speaker, optionally together with controls for user interaction.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

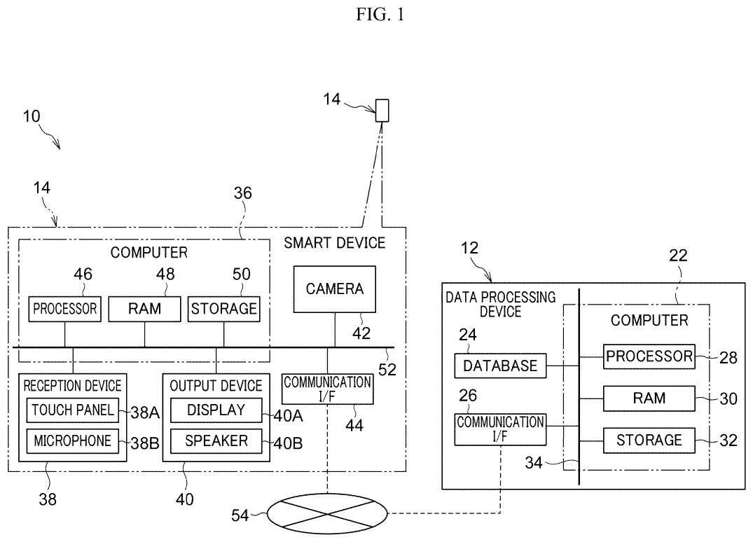

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

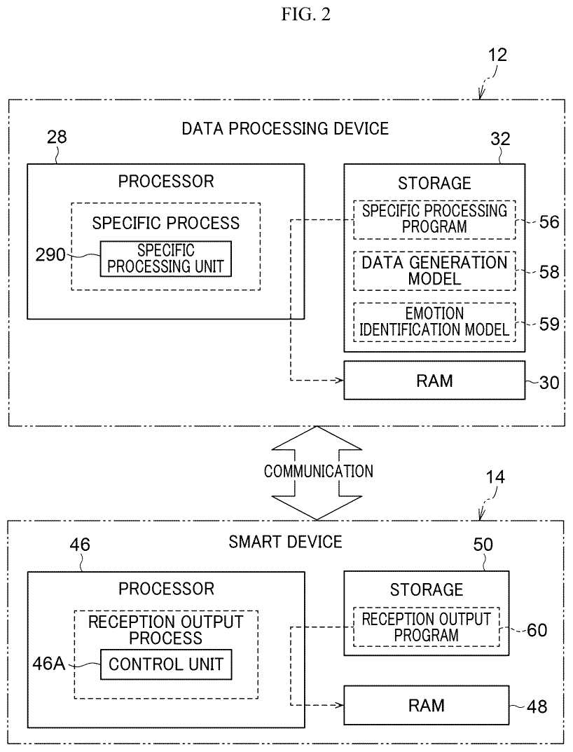

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional recommendation systems generally rely on explicitly provided user metadata, such as textual profiles, manually selected categories, or coarse-grained viewing or listening histories. These systems typically use fixed heuristics or conventional machine learning models that map such metadata to recommended content. As a result, the systems exhibit several technical limitations. First, the systems are not able to efficiently interpret and utilize rich visual information contained in images or videos captured in the course of a user's daily life, because they lack an integrated mechanism that transforms high-dimensional visual data into machine-usable feature representations for downstream retrieval and ranking. Second, even where visual feature extraction is performed, the systems typically separate the similarity search stage from the personalization stage, and do not provide a unified computational framework that combines low-level feature vectors, similarity-based candidate retrieval, and user-specific re-ranking in a coherent processing pipeline. This fragmentation leads to redundant data transformations, increased latency, and suboptimal hardware utilization.

Furthermore, existing systems generally treat large-scale language models or generative models as optional user-facing assistants, rather than as core components of the internal retrieval pipeline. In particular, these systems do not leverage a generative AI model as a ranking engine driven by a structured prompt sentence that encodes visual feature quantities, candidate content sets, and user preference information. Without such integration, the systems are forced to implement complex rule-based logic or multiple specialized models to perform filtering, ranking, and explanation generation, which increases implementation complexity and degrades scalability. Additionally, logging and analysis of model behavior are often insufficiently structured, making it difficult to trace which input conditions and prompts produced specific recommendation outputs, thereby hindering systematic debugging and iterative improvement of the recommendation logic.

Accordingly, there is a need for a computer-implemented technique that improves the way a processor and memory cooperate to (i) extract and represent visual features from media data as numerical feature vectors, (ii) perform efficient similarity search against large content information collections, (iii) generate and supply a structured prompt sentence to a generative AI model to cause coherent ranking and filtering of candidate content, and (iv) record the prompts and intermediate candidate information for subsequent analysis and adaptive personalization. Such a technique should provide a concrete improvement in the functioning of the computer system itself, for example by reducing duplicated processing, enabling more efficient use of generative models as ranking engines, and allowing the system to dynamically tune recommendation behavior based on logged interactions and prompt records. The objective of the present invention is to solve these technical problems by providing a system architecture and processing sequence that tightly integrate visual feature extraction, similarity-based retrieval, generative-model-based ranking, and structured logging, thereby improving the overall efficiency, flexibility, and accuracy of computer-implemented content recommendation.

The specific processing by the specific processing unit 290 of the data processing device 12 in Example 1 is realized by the following means.

The present invention provides a server comprising a processor and a memory storing instructions that, when executed by the processor, cause the processor to perform operations including receiving media information transmitted from a terminal that acquires visual information, the media information including image information or video information obtained in daily life of a user; converting the media information into analysis data and extracting, as numerical data, visual feature quantities including color information, shape information, texture information, and motion information on the basis of the analysis data; generating a search request that uses the visual feature quantities as feature vectors for similarity search and that is used to compare the visual feature vectors with feature vectors of content registered in an information collection, and acquiring a candidate content set from the information collection by using an information retrieval apparatus on the basis of the search request; constructing a prompt sentence for generation of a high-relevance information list on the basis of the candidate content set and the visual feature quantities, inputting the prompt sentence and the candidate content set into a generative artificial intelligence model, and causing the generative artificial intelligence model to perform ranking or filtering of the candidate content set so as to generate the high-relevance information list; formatting the high-relevance information list into output data for transmission to the terminal, and causing the terminal to present the high-relevance information list in a form viewable by the user; and storing, as record information, the prompt sentence and information relating to the candidate content set that are used for generation of the high-relevance information list. This enables an improved computer-implemented recommendation process in which the server internally transforms high-dimensional visual media into feature vectors suitable for similarity search, efficiently retrieves candidate content items, and leverages a generative AI model, via a structured prompt sentence, as a ranking and filtering engine while persistently recording prompts and intermediate candidate information, thereby enhancing the technical performance, traceability, and adaptability of the recommendation system.

The term “media information” refers to digital data including image information or video information that is acquired by a terminal and transmitted to the server for processing.

The term “terminal” refers to an electronic device operated by a user, such as a computing device or communication device, that acquires visual information and transmits corresponding media information to the server.

The term “visual information” refers to information represented in a form perceivable as images or moving images, including still images, video frames, and sequences of frames.

The term “image information” refers to visual information composed of one or more still images represented as digital pixel data.

The term “video information” refers to visual information composed of a temporal sequence of frames represented as digital pixel data.

The term “analysis data” refers to data obtained by converting the media information into a format suitable for computational processing, including normalized pixel values, resized images, extracted frames, or other preprocessed representations.

The term “visual feature quantities” refers to numerical values representing characteristics of visual information, including but not limited to color information, shape information, texture information, and motion information.

The term “color information” refers to numerical data indicating color-related properties of visual information, such as color histograms, dominant colors, or color distributions in a selected color space.

The term “shape information” refers to numerical data indicating geometric or structural properties of objects in the visual information, such as contour descriptors, edge patterns, or region shapes.

The term “texture information” refers to numerical data indicating surface or pattern properties of regions in the visual information, such as frequency components, local pattern descriptors, or statistical measures of pixel variations.

The term “motion information” refers to numerical data indicating temporal changes in visual information, such as movement of objects or camera motion derived from a sequence of frames.

The term “feature vectors” refers to ordered sets of numerical values representing visual feature quantities, used for computational comparison, similarity measurement, and retrieval.

The term “information collection” refers to a stored aggregation of content items, such as media content records, each associated with one or more feature vectors and metadata for retrieval and recommendation.

The term “content” refers to an information item provided to a user, such as an audiovisual item, textual item, or interactive item, that can be included in a recommendation list.

The term “search request” refers to data specifying parameters and feature vectors used to perform similarity search against feature vectors of content registered in the information collection.

The term “information retrieval apparatus” refers to a hardware and software configuration capable of searching the information collection in response to a search request, and returning a set of content items that satisfy similarity or relevance conditions.

The term “candidate content set” refers to a group of content items obtained from the information collection as potential recommendation targets based on similarity between feature vectors.

The term “high-relevance information list” refers to an ordered or filtered list of content items selected from the candidate content set as being most relevant to the media information and, where applicable, to user preferences.

The term “prompt sentence” refers to a machine-readable and human-readable text sequence that encodes visual feature quantities, candidate content information, user preference information, or control instructions, and that is supplied as input to a generative artificial intelligence model.

The term “generative artificial intelligence model” refers to a computational model configured to generate text, data structures, or other outputs in response to inputs including a prompt sentence, and to perform at least ranking, filtering, or explanation generation with respect to the candidate content set.

The term “ranking” refers to assigning an order or relative priority to content items in the candidate content set based on relevance, similarity, or preference criteria.

The term “filtering” refers to selecting, excluding, or grouping content items from the candidate content set based on given conditions, thresholds, or constraints.

The term “output data” refers to data formatted for transmission from the server to the terminal, including the high-relevance information list and associated metadata sufficient for display and interaction.

The term “record information” refers to stored data indicating conditions used during recommendation processing, including at least the prompt sentence and information relating to the candidate content set that contributed to generation of the high-relevance information list.

The term “history information” refers to stored information describing past behavior or interactions of a user, such as previously selected content items, viewing or listening durations, or explicit feedback.

The term “attribute information” refers to data derived from the history information that represents a preference tendency or profile of the user, such as favored genres, themes, or content types.

The term “user interface” refers to a hardware and software configuration at the terminal or server that presents information to the user and receives operations from the user, including graphical displays and input mechanisms.

The term “explanation information” refers to descriptive data, typically natural-language text, indicating reasons, relationships, or contextual information for recommending each content item in the high-relevance information list.

The term “operation information” refers to data describing actions performed by the user via the user interface, including selection operations, browsing operations, and other interaction events.

In one embodiment, a server implements the claimed system as a network-connected computer including at least one processor, a memory, a non-transitory storage device, a network interface, and a graphics interface. The server executes an operating system such as a general-purpose server operating system and application programs including a visual feature extraction module, an information retrieval module, a prompt generation module, a generative AI interaction module, a recommendation list construction module, and a logging and analysis module. The server stores executable instructions and data structures on the storage device and loads them into the memory for execution by the processor.

A terminal implements a user-side device such as a smart device, portable information device, or desktop information device. The terminal includes an image capturing unit, a display unit, an input unit, a wireless or wired communication unit, a processor, and a memory. The terminal acquires visual information in the form of images or videos, and transmits corresponding media information to the server via a communication network such as a wireless network or a wired network. The terminal also receives, stores, and displays high-relevance information lists transmitted from the server and presents recommendation results via a user interface.

A user operates the terminal to capture images or videos in daily life and to initiate transmission of media information to the server. The user further operates the terminal to browse and select recommended content items displayed in the high-relevance information list. The user thus provides interaction data that the server records as history information.

The server uses a visual feature extraction module that is implemented using an image processing library and a machine learning framework. In one example, the server uses a general-purpose image processing library to convert image information and video information into analysis data. The server converts color spaces, resizes image frames to fixed dimensions such as 224×224 pixels, and normalizes pixel values into a predetermined range such as [0,1]. For video information, the server extracts frames at uniform temporal intervals and treats these frames as a frame sequence.

The server computes color information by generating histograms in a chosen color space such as an RGB space or a hue-saturation-value space. The server divides each channel into multiple bins and counts the number of pixels within each bin to create a color feature vector. The server computes shape information by applying edge extraction operations and contour extraction operations and then calculating shape descriptors such as contour area distributions or edge density measures. The server computes texture information by applying local pattern operators and frequency-domain transforms and then generating texture descriptors such as pattern histograms or energy measures. When processing video information, the server computes motion information by estimating inter-frame motion fields, frame difference statistics, or motion vector histograms.

The server concatenates color information, shape information, texture information, and motion information into visual feature quantities represented as feature vectors. These feature vectors are stored in a structured data format in the memory or on the storage device. By compressing high-dimensional visual information into lower-dimensional but discriminative feature vectors, the server reduces memory usage and accelerates similarity search when accessing a large information collection.

In one embodiment, the server further uses a deep learning model implemented with a machine learning framework such as a neural network library to transform analysis data into high-level feature vectors. The server loads a convolutional neural network architecture, for example a residual network or a mobile network, pre-trained on a large set of images. The server removes the final classification layer and uses an intermediate layer as a feature extraction layer. The server inputs normalized images or video frames into the convolutional neural network and obtains a fixed-dimensional deep feature vector from the feature extraction layer. For video information, the server can use a three-dimensional convolutional neural network or an inflated convolutional architecture that directly processes frame sequences and outputs a deep feature vector representing spatio-temporal patterns. The server optionally concatenates or averages multiple deep feature vectors for different frames to generate a unified representation for each media item.

The server stores the resulting feature vectors in association with media identifiers and user identifiers. The server also stores feature vectors of content items in an information collection that includes records for audiovisual items such as music, animation, and film content. Each record in the information collection includes at least a content identifier, a title, metadata such as genre or theme, and one or more feature vectors derived by visual, audio, or textual analysis. The server maintains the information collection in a search index that supports similarity-based retrieval of content records using vector operations such as cosine similarity or inner product.

The server implements an information retrieval module that accepts visual feature quantities generated from newly uploaded media, and constructs a search request. The search request contains the feature vector representing the media information, similarity metric parameters, and retrieval constraints such as a maximum number of candidate content items. The server transmits the search request to the search index or to a retrieval engine. The retrieval engine compares the feature vector against stored feature vectors of content items in the information collection using a vector similarity computation. The retrieval engine returns a candidate content set that includes identifiers, titles, metadata, and similarity scores for multiple content items that are most similar to the visual feature quantities of the uploaded media.

The server then uses a prompt generation module to construct a prompt sentence for a generative AI model. The prompt sentence is a text sequence that encodes at least the following: (i) a description of the visual feature quantities of the media information in human-readable terms such as “dominant blue color” or “outdoor ocean scene”; (ii) a representation of the candidate content set including titles, types, themes, and similarity scores; and (iii) optional preference-related information derived from history information stored for the user. The server can generate textual descriptions of visual feature quantities by mapping ranges of color histogram values and texture descriptors to linguistic labels such as “calm,” “vivid,” “urban,” or “natural.” The server can also summarize candidate content attributes, for example “Song: title A, type: music, tags: sea, relaxing,” or “Animation: title B, type: animated series, tags: summer, adventure.”

The server stores history information describing previous content items that were selected, played, or ignored by the user. The server aggregates this history information into attribute information representing preference tendencies such as frequent selection of calm music, avoidance of horror themes, or interest in family-oriented animation. The server incorporates this attribute information into the prompt sentence as explicit instructions, for example, “The user prefers relaxing songs and family-friendly animation, and avoids horror content.” By explicitly encoding user preferences together with visual feature quantities and candidate content set data, the prompt sentence provides the generative AI model with a comprehensive context for re-ranking and filtering.

The server uses a generative AI interaction module to transmit the prompt sentence and structured candidate content information to a generative AI model. The generative AI model may be implemented as a multi-layer neural network including an input embedding layer, multiple self-attention layers, feed-forward layers, and an output token generation layer. The generative AI model is trained using a loss function such as cross-entropy loss over token sequences, and its parameters are updated by a gradient-based optimization method such as stochastic gradient descent or an adaptive variant. During training, the model is provided with examples of input prompt sentences and desired outputs such as ranked lists, explanations, and filtering decisions. The model thus learns to evaluate relevance relationships between visual descriptions, content descriptions, and user preference descriptions.

The server configures decoding parameters such as output length, sampling temperature, and top-k or top-p constraints to guide the generative AI model's output. The generative AI model generates a text output that includes a high-relevance information list and, optionally, explanation information indicating reasons why each content item is recommended. The server parses the output by identifying item titles or identifiers and extracting explanatory phrases. The server then matches these items with records in the information collection to obtain complete metadata and generate a structured list of recommended items with ranks and explanations.

The server stores the prompt sentence, the candidate content set, and the output of the generative AI model as record information. By retaining this record information, the server enables later analysis of the relationship between input conditions and generated recommendations. This structured logging enables developers to improve the prompt generation logic, adjust the generative AI model's parameters, and diagnose unexpected recommendation behavior. The logging also supports offline evaluation of ranking quality by comparing the generated high-relevance information lists with subsequent user selections.

The server formats the high-relevance information list into output data suitable for transmission to the terminal. The output data can be represented as a structured dataset including content identifiers, titles, summary text, thumbnail references, and explanation information. The server transmits the output data to the terminal via the communication network using a communication protocol such as an application-layer protocol.

The terminal receives the high-relevance information list and displays it to the user via a user interface. The terminal renders visual components such as thumbnails, titles, and explanatory text in a list or grid format. The terminal may emphasize items with higher ranks or show user-relevant tags in a highlighted manner. By presenting not only the recommended items but also explanation information, the terminal allows the user to understand why particular items are recommended in response to the uploaded media information.

The user can select any displayed content item using the input unit of the terminal. When the user selects an item, the terminal initiates playback or access to the corresponding content via a content delivery service or a streaming component. The terminal also transmits operation information back to the server, indicating actions such as item selection, playback duration, or dismissal. The server records this operation information as part of history information and updates the user's attribute information accordingly.

In one concrete example, the user captures a photograph of a blue sky and sea using the terminal and transmits the media information to the server. The server converts the photograph into analysis data and determines, via color histograms, that blue and cyan colors dominate the image. The server extracts texture information indicating a relatively smooth region for the sky and a patterned region for the sea, and shape information indicating a horizontal boundary between these regions. The server may also detect low motion information because the media information is a still image. The server transforms these numerical descriptors into a text description such as “an outdoor scene with blue sky and ocean, calm and bright.”

The server uses the resulting feature vector to query the information collection and obtain a candidate content set including items tagged with themes such as sea, summer, and relaxing. The server then constructs a prompt sentence, for example:

“The user has uploaded an image showing a bright blue sky and ocean. The extracted visual features indicate dominant blue color, a calm outdoor sea scene, and low motion. The following candidate contents have been retrieved from the content collection:
1) Song: ‘Ocean Breeze Melody’ (type: music, tags: sea, relaxing, summer)
2) Animation: ‘Summer Vacation at the Coast’ (type: animation, tags: sea, family, adventure)
3) Movie: ‘Skyline Reflections’ (type: film, tags: sky, youth, drama).

The user prefers relaxing songs and family-friendly animation and avoids horror content. Based on the image description, the candidate contents, and the user's preferences, rank these contents from most to least relevant and provide a brief explanation for each recommendation.”

The server supplies this prompt sentence and structured candidate content attributes to the generative AI model. The generative AI model produces an ordered list where, for example, the relaxing sea-themed song and the family-oriented sea animation are ranked above the drama film. The generative AI model also outputs explanation information such as “Recommended because the calm sea theme and relaxing mood match the blue ocean image and the user's preference for relaxing music.” The server constructs a high-relevance information list from this output and transmits it to the terminal.

This configuration produces technical effects that improve the functioning of the computer system itself. By compressing visual information into structured feature vectors and performing similarity search directly on those vectors, the server reduces the computational complexity of searching a large information collection compared to naive pixel-wise comparison or purely text-based matching. By using a generative AI model not as a mere conversational agent but as a ranking and filtering engine driven by a prompt sentence that encodes visual feature quantities and user preference attributes, the server reduces the need for multiple separate rule-based engines and enables more flexible and accurate re-ranking with fewer fixed heuristics.

The server's storage of prompt sentences and candidate content sets, along with resulting recommendation outputs and subsequent user interaction data, enables iterative refinement of the generative AI model and the prompt generation process. This structured feedback loop improves the accuracy and stability of recommendations over time. The use of a deep neural network for feature extraction and a generative AI model for ranking allows the system to handle high-dimensional data efficiently and to exploit non-linear relationships between visual features, candidate content attributes, and user preferences that are difficult to model by linear or rule-based methods.

Additionally, the described architecture reduces response latency by decoupling feature extraction and similarity search from generative re-ranking. The server can pre-compute and index content feature vectors and execute high-throughput vector searches using specialized data structures such as approximate nearest neighbor indices. The generative AI model then processes only a limited candidate content set and a structured prompt sentence, which is significantly smaller in size than the full information collection. This division of tasks optimizes computation load and reduces network traffic between internal modules.

In further embodiments, the server may implement different neural network architectures for feature extraction, such as a vision transformer model or a hybrid model that combines convolutional and attention layers. The server may also vary the loss function used during training of the generative AI model, for example by incorporating ranking-based loss terms that encourage correct ordering of candidate items according to observed user selections. Data augmentation techniques such as random cropping, color jittering, or frame subsampling can be employed during training of the visual feature extraction model to increase robustness to variations in input media.

In yet another embodiment, the server may adjust the structure of the prompt sentence to include more explicit numerical values such as normalized similarity scores, content popularity indicators, or user preference strength values. The server may map these numerical values into controlled natural-language phrases to ensure consistent input distribution for the generative AI model. The server can also introduce internal rule-based constraints, for example excluding content items with themes tagged as disallowed for a given user, before passing the candidate content set to the generative AI model. This hybrid rule-based and generative approach ensures both safety and flexibility.

Through these embodiments, the server, the terminal, and the user cooperate to implement a recommendation system that not only automates selection of relevant content but also improves the internal technical processes of feature extraction, data representation, retrieval, ranking, and logging within the computing environment. The generative AI model and the prompt sentence are integrated into a concrete data processing pipeline that transforms raw media data into structured, high-relevance information lists with improved precision, computational efficiency, and adaptability.

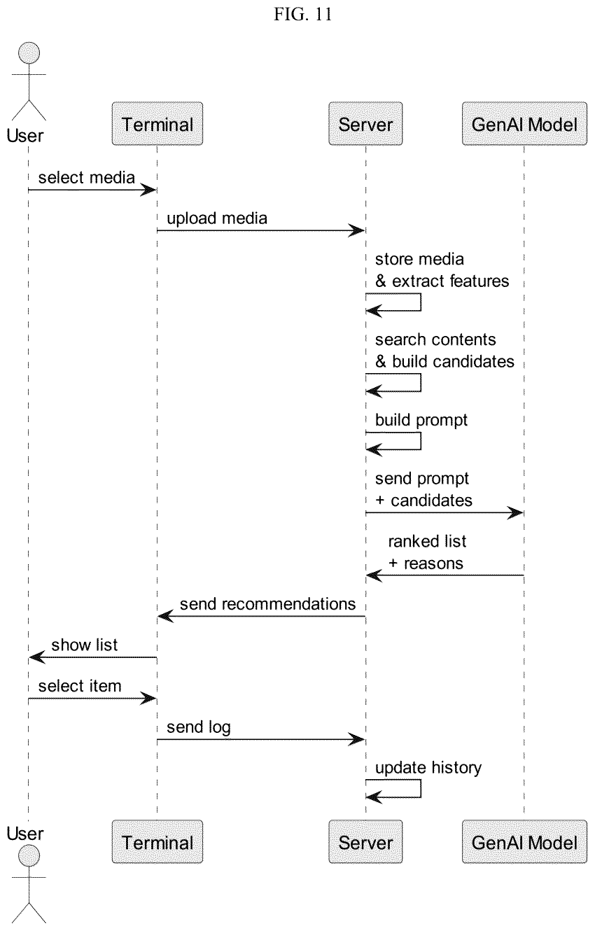

The following describes the processing flow using FIG. 11.

### Step 1

The user operates the terminal and selects one or more media files, such as images or videos, that were captured in daily life.

Input: visual information stored on the terminal (for example, image files and video files).

Output: a selection of media files designated for upload.

The terminal displays a file selection interface, reads metadata of the selected files, and prepares a list of file paths and file types for transmission.

### Step 2

The terminal transmits media information corresponding to the selected media files to the server via a communication network.

Input: the selected media files and their metadata on the terminal.

Output: an upload request containing media information sent to the server.

The terminal packages the media files and metadata into a request message, converts the files into a transmittable binary format, and sends the request through a communication unit to a reception endpoint of the server.

### Step 3

The server receives the media information and stores it in a storage device for subsequent processing.

Input: the upload request including one or more media files and metadata.

Output: stored media data and associated media identifiers.

The server parses the received message, extracts binary media data and metadata, assigns unique identifiers to each media item, and writes the media data into a file system or an object storage while recording references in a management table in memory.

### Step 4

The server converts the stored media data into analysis data suitable for visual feature extraction.

Input: stored media data and media identifiers.

Output: normalized image frames and preprocessed video frames as analysis data.

The server decodes image files into pixel matrices, decodes video files into sequences of frames, resizes images and frames to a standard resolution, and normalizes pixel values to a predetermined numeric range so that subsequent algorithms can operate on a consistent representation.

### Step 5

The server extracts basic visual feature quantities from the analysis data using image processing operations.

Input: normalized image frames and preprocessed video frames.

Output: numerical descriptors representing color information, shape information, texture information, and motion information.

The server computes color histograms over a selected color space, applies edge detection and contour analysis to derive shape descriptors, applies local texture operators to compute texture descriptors, and calculates frame differences or motion vectors to produce motion descriptors, then combines these descriptors into feature vectors for each media item.

### Step 6

The server generates high-level feature vectors from the analysis data using a neural network model.

Input: normalized image frames and preprocessed video frames.

Output: deep feature vectors representing high-level visual patterns.

The server inputs the analysis data into a trained neural network model, obtains activations from an intermediate layer as numerical outputs, and aggregates these outputs (for example, by averaging across frames) into fixed-length vectors that encode semantic properties of the media content.

### Step 7

The server constructs a combined visual feature vector for each media item by integrating basic visual feature quantities and high-level feature vectors.

Input: basic visual feature vectors and deep feature vectors associated with a media identifier.

Output: integrated visual feature vectors stored with media identifiers.

The server concatenates or otherwise fuses the basic feature vectors and the deep feature vectors, applies optional normalization or dimensionality reduction, and stores the resulting integrated vectors in a feature store linked to corresponding media identifiers.

### Step 8

The server generates a search request for an information collection based on the integrated visual feature vector.

Input: an integrated visual feature vector associated with a target media item.

Output: a search request containing a feature vector and retrieval parameters.

The server packages the integrated visual feature vector into a structured query, specifies a similarity metric, sets retrieval limits such as a maximum number of candidates, and formats the query according to the protocol of an information retrieval apparatus.

### Step 9

The server acquires a candidate content set from the information collection by executing the search request on an information retrieval apparatus.

Input: the structured search request containing the integrated visual feature vector.

Output: a candidate content set including identifiers, metadata, and similarity scores.

The server transmits the search request to the retrieval apparatus, triggers a similarity computation between the query feature vector and stored feature vectors of content items, receives the most similar items and their similarity scores, and composes a candidate content list in memory.

### Step 10

The server acquires history information related to the user and derives attribute information representing user preference tendencies.

Input: a user identifier and stored history information records.

Output: attribute information describing user preferences.

The server reads past interaction logs such as selected items and viewing durations, aggregates occurrence frequencies of content types and themes, calculates preference scores for attributes such as genre or mood, and encodes these scores into an attribute vector or structured preference description.

### Step 11

The server generates descriptive text for visual feature quantities and candidate content attributes.

Input: integrated visual feature vectors and the candidate content set.

Output: textual descriptions of the visual characteristics and candidate content summaries.

The server maps ranges of numerical feature values to qualitative labels (for example, “dominant blue color” or “calm outdoor scene”), selects representative metadata for each candidate content item, and constructs short text snippets describing each item's type, tags, and themes.

### Step 12

The server constructs a prompt sentence for a generative AI model by combining visual descriptions, candidate content summaries, and user preference information.

Input: textual visual descriptions, candidate content summaries, and attribute information representing user preferences.

Output: a prompt sentence encoding context and ranking instructions.

The server arranges the text elements in a predefined template, inserts explicit instructions such as ranking criteria and constraints, and generates a coherent text sequence that describes the media, lists the candidate contents, and states user preferences and required output format.

### Step 13

The server transmits the prompt sentence and structured candidate content data to a generative AI model and obtains a text output including a high-relevance information list.

Input: the prompt sentence and structured candidate content data.

Output: generated text describing a ranked or filtered content list and, optionally, explanations.

The server sends the prompt and candidate attributes to the generative AI model, configures generation parameters such as output length and decoding strategy, receives the generated output text, and stores the response in memory for further parsing.

### Step 14

The server parses the generated text and converts it into a structured high-relevance information list.

Input: generated text containing recommended content items and explanations.

Output: a structured list of recommended items with ranks, identifiers, and explanations.

The server analyzes the text to extract content titles or identifiers and associated explanation segments, matches extracted titles or identifiers against the candidate content set, assigns ranks based on the textual order or explicit ranking indicators, and builds a data structure representing the recommended list.

### Step 15

The server enriches the high-relevance information list with content metadata and prepares output data for transmission.

Input: the structured high-relevance information list and content metadata from the information collection.

Output: output data including complete recommendation information.

The server retrieves thumbnails, descriptions, and access links for each recommended item, attaches these fields to the corresponding entries in the list, formats the list in a structure suitable for network transmission, and associates the list with the corresponding user and media identifiers.

### Step 16

The server transmits the output data containing the high-relevance information list to the terminal.

Input: formatted output data prepared for the user.

Output: a response message containing the high-relevance information list delivered to the terminal.

The server encapsulates the output data in a response protocol message, sends the message over the communication network to the terminal, and records a log entry indicating that the recommendation result has been delivered.

### Step 17

The terminal receives the high-relevance information list and presents it to the user via a user interface.

Input: the response message containing the high-relevance information list.

Output: a visual representation of recommended content displayed on the terminal.

The terminal decodes the received message, extracts the list of recommended items and associated metadata, constructs a list or grid layout, loads thumbnail images as needed, and renders titles and explanations on the display so that the user can review and select items.

### Step 18

The user interacts with the displayed high-relevance information list and performs selection or browsing operations.

Input: the visual representation of recommended content items on the terminal.

Output: user interaction events such as selections, scrolls, or dismissals.

The user taps or clicks recommended items, scrolls through the list, or closes the interface, thereby generating operation inputs that the terminal interprets as interaction events.

### Step 19

The terminal records user interaction events and transmits operation information to the server.

Input: raw interaction events produced by the user on the user interface.

Output: operation information describing selections and browsing behavior sent to the server.

The terminal converts events such as item selection, playback start, or list scrolling into structured records including timestamps and item identifiers, groups these records into a message, and sends the message to the server for logging.

### Step 20

The server updates history information and attribute information based on the received operation information.

Input: operation information describing the user's interactions and existing history information.

Output: updated history information and updated attribute information for the user.

The server appends new interaction records to the user's history, recalculates preference scores by adjusting counts or weights for content attributes, updates the attribute vector or preference profile, and stores the updated information in a database to influence subsequent prompt sentence generation and recommendation processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional information recommendation systems, a processor typically performs feature extraction on input image data or video data, and then directly applies a fixed retrieval algorithm or a static similarity search engine to obtain related content from a data store. In such systems, a prompt sentence for a generative AI model is either not used, or is limited to a simple, manually designed query that does not fully leverage rich visual semantics, temporal context, or user-specific preference information. As a result, the generated recommendation list often fails to accurately reflect both the nuanced content of the input media and the evolving preferences of the user, thereby limiting the technical performance of the recommendation engine in terms of relevance, personalization, and adaptability.

Moreover, in many existing systems, a generative AI model is invoked in an isolated manner: the model is supplied with plain text queries that are not systematically derived from machine-interpretable visual feature vectors or user interaction logs, and the model's outputs are not tightly integrated with numerical similarity computation or machine learning-based ranking. This separation leads to inefficient use of computational resources and sub-optimal ranking accuracy, because the system cannot consistently reconcile symbolic recommendations generated by the generative model with vector-based similarity measures computed over large-scale content embeddings.

Further, conventional systems generally do not maintain a structured history of generated prompt sentences and personalized recommendation lists, nor do they use such histories as feedback to iteratively refine the prompt generation logic. Consequently, the system is unable to improve its internal prompt construction strategy over time based on observed user behavior, leading to a lack of self-optimization at the system level and an inability to adapt to distributional shifts in user preferences, content catalogs, and model behavior.

In addition, known techniques often treat user behavior information, such as click logs, play durations, or explicit ratings, merely as input for a separate recommendation model, without feeding such information back into the process of constructing the next prompt sentence for the generative AI model. This architectural separation prevents the processor from dynamically tailoring the prompt sentence to reflect user-specific preference patterns, such as preferred content types, preferred presentation styles, or preferred list sizes, thereby limiting the system's ability to generate computationally efficient, high-precision candidate sets from the generative AI model.

Accordingly, there is a need for a system and associated techniques that improve computer technology by tightly integrating (i) extraction of visual feature information from still image information or moving image information, (ii) construction and adaptive refinement of prompt sentences supplied to a generative AI model, (iii) vector-space similarity computation between media features and content features, and (iv) machine learning-based personalization using user characteristic information. Such a system should enable a processor to automatically generate and update prompt sentences, efficiently obtain a relevance information list via a generative AI model, and transform that list into a personalized information list with improved ranking accuracy and responsiveness to user feedback, while also reducing manual prompt engineering workload and improving the overall throughput and quality of the recommendation pipeline.

The specific processing by the specific processing unit 290 of the data processing device 12 in Application Example 1 is realized by the following means.

The present invention provides a server comprising a processor configured to extract visual feature information from still image information or moving image information by using an analysis unit, to generate a prompt sentence for searching an information set for related information items on the basis of the extracted visual feature information and on the basis of scene information or affective information estimated from the still image information or the moving image information, to search the information set by using a generative information processing model on the basis of the prompt sentence and the visual feature information and to generate a relevance information list including candidate information items related to content of the still image information or the moving image information, to calculate, for each information item included in the relevance information list, a similarity degree between the visual feature information and a pre-calculated feature representation of each information item and to update the relevance information list on the basis of the similarity degree, to input user characteristic information including behavior history information or evaluation information of a user into a machine learning model as input feature information with respect to the relevance information list, to calculate an individuality evaluation value for each information item by using the machine learning model and to rank the relevance information list on the basis of the individuality evaluation value to generate a personalized information list, and to store generation histories of the prompt sentence and the personalized information list and to update generation conditions of the prompt sentence on the basis of an accumulation result of the generation histories. This enables improvement of computer-implemented recommendation processing by allowing the server to automatically construct and iteratively refine prompt sentences supplied to a generative AI model in accordance with visual feature information and user characteristic information, to integrate model-generated candidate information items with vector-space similarity computation and machine learning-based ranking, and thereby to generate personalized information lists with enhanced relevance, adaptability, and computational efficiency compared to conventional systems.

The term “processor” refers to a hardware computing element, or a combination of hardware and firmware, that executes instructions to perform data processing operations described in the present disclosure.

The term “still image information” refers to digital data representing a single frame or a plurality of static frames, each frame including pixel values or equivalent representation suitable for visual analysis.

The term “moving image information” refers to digital data representing a sequence of image frames over time, such as video data, including temporal continuity information suitable for motion or scene analysis.

The term “visual feature information” refers to numerical or symbolic data representing properties of still image information or moving image information, including but not limited to color distributions, shapes, textures, edges, or other image-derived descriptors.

The term “analysis unit” refers to a functional component implemented by hardware, software, or a combination thereof, which is configured to process still image information or moving image information to extract visual feature information.

The term “information set” refers to a collection of stored data items, such as content metadata, content descriptors, or content records, maintained in one or more storage devices and searchable by the processor.

The term “information item” refers to an individual element contained in the information set, such as a record, an entry, or an object, which may correspond to media content, metadata, or other retrievable data.

The term “prompt sentence” refers to a sequence of text tokens or equivalent structured textual data generated by the processor, which is supplied as an input query or instruction to a generative information processing model to control or constrain the model's output.

The term “generative information processing model” refers to a machine-implemented model, such as a neural network-based generative AI model, that receives input data including at least a prompt sentence and generates output data such as recommendations, rankings, or textual descriptions.

The term “relevance information list” refers to a data structure that includes a plurality of information items selected from the information set and associated with the still image information or the moving image information, the plurality being ordered or annotated according to a measure of relevance.

The term “feature representation” refers to a numerical vector or equivalent structured representation that encodes characteristics of an information item in a feature space suitable for similarity computation.

The term “similarity degree” refers to a quantitative value obtained by applying a similarity measure, such as cosine similarity or distance-based metrics, between two feature representations, and indicating a level of resemblance between them.

The term “user characteristic information” refers to data describing attributes or behaviors of a user, including but not limited to behavior history information, evaluation information, demographic information, and inferred preference information.

The term “behavior history information” refers to data indicating past interactions of a user with information items or system outputs, such as selections, clicks, playback events, browsing actions, or other interaction logs.

The term “evaluation information” refers to data indicating explicit or implicit assessments by a user regarding an information item, such as ratings, likes, dislikes, bookmarks, or similar preference indicators.

The term “machine learning model” refers to a computational model trained on example data to learn a mapping from input feature information to output values, the model being implemented by software, hardware, or a combination thereof.

The term “input feature information” refers to numerical or symbolic data supplied to a machine learning model, including representations of information items, user characteristic information, or other contextual information.

The term “individuality evaluation value” refers to a numerical score output by the machine learning model that represents a degree of suitability or preference of a given information item with respect to a particular user.

The term “personalized information list” refers to a relevance information list that has been re-ordered or filtered based on user characteristic information and individuality evaluation values so as to be tailored to a specific user.

The term “generation history” refers to recorded data indicating when and how a prompt sentence or a personalized information list was generated, including conditions, parameters, intermediate results, and associated identifiers.

The term “generation condition” refers to a parameter, rule, template, or other control value used by the processor when generating a prompt sentence, including but not limited to content type constraints, list size constraints, preference constraints, or linguistic style constraints.

The term “display control unit” refers to a functional component executed on a user terminal, implemented by software, hardware, or a combination thereof, which is configured to control presentation of information items on a display device.

The term “user terminal” refers to an electronic apparatus operated by a user, such as a mobile device, a personal computer, or another computing device, that communicates with the server and presents information to the user.

The term “list format” refers to a presentation style in which multiple information items are displayed as an ordered or unordered list, typically arranged in a linear or tabular structure.

The term “classified format” refers to a presentation style in which multiple information items are grouped into categories or classes and displayed according to such grouping, for example by genre, theme, or other classification criteria.

The term “selection operation information” refers to data indicating operations performed by a user on presented information items, such as selecting, activating, confirming, or skipping items, which is used as feedback for learning or updating models.

In one embodiment, a server implements the claimed system by executing a software program on a hardware platform that includes at least one general-purpose central processing unit, at least one graphics processing unit, a main memory, a non-volatile storage device, and a network interface. The server runs an operating system such as a UNIX-like operating system and hosts an application server program that exposes application programming interfaces to one or more terminals over a communication network. The terminals include, for example, mobile communication devices or personal computing devices operated by a user. The terminals execute a client program or a web browser to transmit image data and video data to the server and to present recommended information items to the user.

The server includes an analysis unit implemented in software and configured to extract visual feature information from still image information and moving image information. The server uses an image processing library, such as a library providing matrix operations, color space conversion, histogram computation, edge detection, and texture filtering. The server loads the still image information or the moving image information from a storage device into main memory, decodes the data into pixel matrices, and converts the pixel values into a color space such as RGB or HSV. The server computes color histograms, edge maps, and texture descriptors for one or more image regions or video frames. The server stores the computed visual feature information as fixed-length numerical vectors, such as arrays of floating-point values, in a feature storage area.

The server further includes a semantic estimation unit implemented using a deep learning framework, such as a framework providing tensor operations and automatic differentiation. The server loads a trained neural network model into the graphics processing unit. In one example, the neural network model comprises a stack of convolutional layers, batch normalization layers, non-linear activation layers, and fully connected layers, optionally combined with an attention mechanism. In another example, the neural network model comprises a transformer-based architecture receiving image patches as input tokens and computing contextualized embeddings.

The server converts the visual feature information and, when appropriate, the raw pixel matrices into input tensors and provides the tensors to the neural network model. The neural network model outputs a semantic embedding, which is a dense vector of a predetermined dimension, and probability values for a plurality of scene labels and affective labels. The scene labels include, as examples, “indoor,” “outdoor,” “urban,” “nature,” “daytime,” “night,” and similar categories. The affective labels include, as examples, “calm,” “energetic,” “romantic,” and similar mood indicators. The server stores the semantic embedding and the label probabilities in association with an identifier of the still image information or the moving image information.

The server generates a prompt sentence by combining descriptive terms derived from the semantic embedding, the label probabilities, and optional metadata received from the terminal. The server constructs the prompt sentence according to a template stored in a prompt template storage area. The server selects specific expressions for scene information and affective information based on threshold processing applied to the label probabilities and based on vector similarity between the semantic embedding and reference embeddings for known concepts. As a result, the prompt sentence encodes a rich, machine-derived description of the content rather than a simple human-crafted keyword query.

For example, when the still image information depicts cherry blossoms under a clear sky in spring, the server generates a prompt sentence such as:

“Based on an image showing pink cherry blossoms, blue sky, and a calm spring atmosphere, recommend suitable background music tracks and anime movies that match this mood.”

In another example, when the moving image information shows a neon-lit city at night, the server generates a prompt sentence such as:

“Given a video of a neon-lit night city with fast camera motion and an energetic, cyberpunk-like mood, list high-tempo electronic or synthwave tracks and science-fiction movies that fit this atmosphere.”

In still another example, when the still image information shows a snowy mountain at dusk, the server generates a prompt sentence such as:

“Based on an image of a quiet snowy mountain at dusk, recommend relaxing instrumental music tracks and movies suitable for a calm winter evening.”

The server supplies the prompt sentence and, in some embodiments, additional numerical context derived from the semantic embedding to a generative AI model. The generative AI model is implemented as a large-scale neural network, for example a transformer-based language model with self-attention layers, feed-forward layers, and layer normalization. The server executes the generative AI model either locally on the graphics processing unit or remotely via a model hosting service, using text tokens derived from the prompt sentence as input. The generative AI model outputs a sequence of tokens that the server decodes into one or more candidate information item descriptions, such as content types, genres, themes, or indicative titles.

The server parses the output of the generative AI model to obtain structured recommendation hints. The server converts these hints into constraint data and weighting factors used by a retrieval unit. The retrieval unit accesses an information set stored in one or more databases. The information set includes content records, each record having a record identifier, metadata fields, and a pre-calculated feature representation created by a content indexing process. The content indexing process uses another neural network or a dimensionality reduction algorithm, such as a convolutional encoder or a principal component analysis module, to map content attributes into fixed-length feature representations.

The server compares the semantic embedding derived from the still image information or the moving image information with the pre-calculated feature representation of each candidate content record. The server computes a similarity degree using, for example, cosine similarity, Euclidean distance, or a learned metric implemented by a small neural network. The server aggregates the similarity degrees, the constraint data from the generative AI model, and the content metadata to generate a relevance information list. The relevance information list is a data structure stored in memory that contains, for each candidate information item, an identifier, one or more feature representations, one or more similarity degrees, and one or more scores derived from the generative AI model output.

The server updates the relevance information list by re-computing and normalizing the scores using a deterministic algorithm configured to resolve conflicts between different scoring sources. The server may apply a weighted linear combination, a learned ranking function, or a non-linear fusion function to integrate semantic similarity, generative AI model scores, and metadata-based weights. The server thus generates a relevance information list that is already optimized according to image-based or video-based semantics but is not yet individualized for a specific user.

The server stores user characteristic information in a user profile storage area. The user characteristic information includes behavior history information and evaluation information obtained from terminal interactions. For example, when the user selects a recommended item, completes playback of a media item, explicitly rates an item, or skips an item after a short duration, the terminal transmits corresponding interaction data to the server. The server normalizes and aggregates the interaction data into user vectors, including counts, time-weighted scores, and contextual features such as time of day or device type. The server also stores embedding representations of users in a user feature space, computed using a collaborative filtering model or a neural network model.

The server provides the relevance information list and the user characteristic information as input feature information to a machine learning model configured as a ranking network. In one embodiment, the ranking network includes embedding layers for user features and item features, concatenation layers, and fully connected layers with non-linear activations. The server feeds the concatenated features into the ranking network to compute an individuality evaluation value for each information item. The individuality evaluation value represents an estimated probability that the user will select, consume, or positively evaluate the information item.

The server uses the individuality evaluation values to re-rank the relevance information list. The server sorts the information items according to decreasing individuality evaluation values and may discard items with scores below a threshold. The server thus generates a personalized information list tailored to the user. The server stores the personalized information list in association with the prompt sentence, the semantic embedding, and identifiers of the visual input, thereby forming a generation history.

The server accumulates generation histories over time and uses them to refine generation conditions for subsequent prompt sentences. The server analyzes the correlation between elements of the prompt sentences, the resulting personalized information lists, and the subsequent user behavior. Using this analysis, the server updates parameters of a prompt construction module, such as template selection rules, weightings for scene information and affective information, and default list sizes. In some embodiments, the server trains a separate neural network for prompt optimization; this network takes as input the semantic embedding and user characteristic information and outputs control parameters for template selection and token choices in the prompt sentence. This adaptive update mechanism is different from manual prompt engineering and enables the system to improve its internal text generation strategy according to quantifiable performance indicators such as click-through rate and satisfaction metrics.

The terminal receives the personalized information list from the server in a structured format and controls a display device to present the list to the user. The terminal displays each information item with a representation such as a title, an image, or a brief description. The terminal may group the information items into categories or present them in a single ordered list. When the user performs a selection operation, the terminal transmits selection operation information to the server. The server interprets this selection operation information as additional behavior history information and feeds it back into the machine learning model and the prompt construction module.

This configuration provides technical effects that go beyond mere automation of human selection or manual search. The server integrates visual feature extraction, generative AI-based content generation, vector-space similarity computation, and machine learning-based personalization into a single, tightly coupled pipeline. By representing both the visual input and the candidate information items as numerical vectors and by combining these vectors with text-based outputs of the generative AI model, the server reduces search space and improves retrieval precision. The usage of semantic embeddings and learned similarity measures allows the server to identify relevant items even when explicit keywords are absent or ambiguous, which cannot be achieved by human operators or rule-based systems with similar efficiency.

Furthermore, the server reduces computational overhead by employing multi-stage filtering. The generative AI model narrows down the conceptual domain; the vector similarity module filters candidates in the feature space; and the ranking network focuses only on the most promising items. This staged approach reduces the number of expensive model evaluations and database accesses, thereby improving processing speed and scalability. The server also reduces communication load between the server and the terminals by transmitting only the personalized information list and necessary identifiers, instead of transmitting large content collections or raw model outputs.

The described system improves computer technology in several ways. First, the adaptive prompt construction mechanism increases the accuracy and stability of generative AI model outputs by aligning text instructions with machine-interpretable visual features and accumulated user behavior data. Second, the integration of generative outputs with numerical similarity and ranking networks enables more accurate and efficient computation compared to using each technique in isolation. Third, the continuous learning loop, in which selection operation information updates both user embeddings and prompt generation conditions, allows the system to self-optimize over time in response to new content and changes in user preferences.

The server performs these operations according to explicit algorithms and data structures, rather than abstract human-like judgment. For example, the server computes gradients and updates model weights during training using an optimization algorithm such as stochastic gradient descent or Adam, with an objective function such as cross-entropy loss or pairwise ranking loss defined over observed user interactions. The server may perform data augmentation procedures on training images and videos, such as random cropping, flipping, color jittering, and temporal sampling, to improve model robustness. The server represents prompts, embeddings, and lists in well-defined data types in memory and processes them through deterministic control flows.

The system can be implemented in multiple variations. In one variation, the server executes the generative AI model locally; in another, the server communicates with an external model service over a secure communication protocol. In one variation, the machine learning model for personalization is a matrix factorization model; in another variation, it is a deep neural ranking model. In one variation, the semantic estimation unit operates only on visual feature information; in another, it also incorporates textual tags or sensor metadata from the terminal. These variations still rely on the same fundamental structure: a server generating and adapting a prompt sentence based on visual and user features, a generative AI model producing candidate guidance, a similarity computation module refining candidates using numerical feature representations, and a machine learning model generating personalized rankings.

By virtue of these configurations, the system as implemented by the server and the terminals provides a concrete technical solution in which the generative AI model and associated prompt sentences are embedded into a structured, machine-interpretable pipeline that enhances recommendation accuracy, reduces latency and computational cost, and improves the way visual media and large-scale content sets are processed by computer systems.

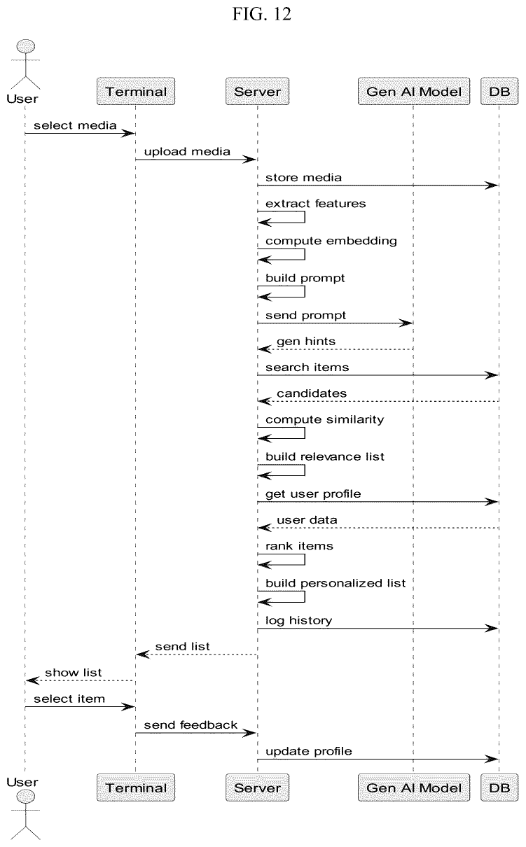

The following describes the processing flow using FIG. 12.

### Step 1

User acquires still image information or moving image information.

User operates a camera function or gallery function on the terminal to capture or select an image or video. The input of this step is physical scene information in the real world, which is converted by the terminal into digital pixel data stored as an image file or video file. The output of this step is stored media data on the terminal, represented as a file path and associated media metadata such as resolution, duration, and format.

### Step 2

Terminal transmits media data and basic metadata to the server.

Terminal reads the selected image or video file from local storage and constructs a network request containing the media binary data and metadata (for example, media type, size, and user identifier). The input of this step is the local media file and metadata on the terminal; the terminal applies data serialization and network encapsulation to generate a request message. The output of this step is an uploaded media request delivered to the server over a communication network.

### Step 3

Server stores received media data and registers a media record.

Server receives the network request, verifies user authentication information, and writes the image or video data to a non-volatile storage device in a designated directory. The input of this step is the uploaded media request; the server performs file I/O operations and simple validation checks. The output of this step is a stored media file and a new media record in a database, including a media identifier, a file path, and basic attributes.

### Step 4

Server decodes media data and extracts low-level visual feature information.

Server loads the stored media file from the storage device into main memory and decodes the pixel data by using an image and video processing library. The input of this step is the media file and its path; the server applies color space conversion, histogram computation, edge detection, and texture filtering to the pixel matrices. The output of this step is a set of numerical low-level feature vectors, such as color histograms, edge descriptors, and texture descriptors, associated with the media identifier.

### Step 5

Server computes high-level semantic embedding and label probabilities.

Server provides the low-level feature vectors and, optionally, sampled pixel matrices to a neural network model running on a graphics processing unit. The input of this step is the visual feature information and image or frame tensors; the server performs tensor multiplication, non-linear activation, and normalization to propagate data through the neural network layers. The output of this step is a semantic embedding vector and probability distributions over scene labels and affective labels linked to the media identifier.

### Step 6

Server generates descriptive terms for scene information and affective information.

Server analyzes the label probabilities and the semantic embedding to select dominant scene concepts and mood descriptors. The input of this step is the semantic embedding and label probability values; the server applies thresholding, ranking, and similarity comparison against reference concept vectors. The output of this step is a small set of textual descriptors, such as “pink cherry blossoms,” “blue sky,” “calm spring atmosphere,” or “neon-lit night city, energetic mood.”

### Step 7

Server constructs a prompt sentence for a generative AI model.

Server inserts the selected textual descriptors into a predefined template and optionally adds constraints such as the number and type of desired information items. The input of this step is the textual descriptors and template data; the server performs string concatenation, token insertion, and conditional phrase selection. The output of this step is a complete prompt sentence, for example:

“Based on an image showing pink cherry blossoms, blue sky, and a calm spring atmosphere, recommend suitable background music tracks and anime movies that match this mood.”

### Step 8

Server transmits the prompt sentence and context data to a generative AI model.

Server encodes the prompt sentence into tokens and sends the tokens and optional context identifiers to a generative AI model executing locally or remotely. The input of this step is the plain-text prompt sentence and, optionally, a compact representation of the semantic embedding. The server converts text to token IDs and organizes them into a model input structure. The output of this step is a model invocation request including tokenized input and configuration parameters such as maximum output length.

### Step 9

Server receives generative AI model output and derives recommendation hints.

Server collects the token sequence produced by the generative AI model and decodes it back into text. The input of this step is the tokenized output from the model; the server performs token-to-text decoding and text parsing. The output of this step is structured recommendation hints, such as candidate content categories, descriptive phrases for desired music and video, and suggested numbers of items.

### Step 10

Server searches an information set for candidate information items.

Server uses the recommendation hints together with the semantic embedding to query a database containing pre-indexed content records. The input of this step is the recommendation hints, semantic embedding, and database index; the server executes search queries, including vector similarity search and metadata filtering. The output of this step is an initial set of candidate information items retrieved from the information set, each item having an identifier, metadata, and a pre-calculated feature representation.

### Step 11

Server computes similarity degrees between media features and content features.

Server compares the semantic embedding of the media and the feature representation of each candidate information item. The input of this step is the semantic embedding and item feature vectors; the server performs numerical operations such as dot products and norm calculations to obtain similarity measures. The output of this step is a list of similarity degrees, one for each candidate information item, appended to the candidate set.

### Step 12

Server generates and updates a relevance information list.

Server integrates the similarity degrees, the recommendation hints from the generative AI model, and the metadata constraints into a unified scoring scheme. The input of this step is the candidate item set with similarity scores and hint weights; the server applies weighted scoring formulas and sorting algorithms. The output of this step is a relevance information list, which is an ordered list of information items ranked by combined relevance with respect to the media content.

### Step 13

Server retrieves user characteristic information.

Server accesses a user profile storage area to obtain behavior history information and evaluation information for the user. The input of this step is the user identifier; the server executes database queries and aggregates logs of past selections, ratings, and playback events. The output of this step is a set of user feature vectors and statistics describing the user's preference patterns.

### Step 14

Server computes individuality evaluation values using a machine learning model.

Server passes the relevance information list and the user characteristic information into a ranking model. The input of this step is the item feature representations, the user feature vectors, and derived interaction features; the server performs neural network inference or matrix factorization operations to map these features to preference scores. The output of this step is an individuality evaluation value for each information item, indicating estimated suitability for the user.

### Step 15

Server generates a personalized information list by re-ranking.

Server sorts the items in the relevance information list according to their individuality evaluation values and optionally removes items that fall below a defined threshold. The input of this step is the relevance information list and the individuality evaluation values; the server applies sorting and filtering algorithms. The output of this step is a personalized information list, which is a re-ordered and refined list of information items tailored to the user.

### Step 16

Server stores generation history for later optimization.

Server records the prompt sentence, the semantic embedding, the relevance information list, the personalized information list, and subsequent user interaction identifiers as a generation history entry. The input of this step is all intermediate data generated during the recommendation process; the server writes this data to a log or analytics storage area. The output of this step is an updated history dataset used for future refinement of prompt generation conditions and ranking models.

### Step 17

Server transmits the personalized information list to the terminal.

Server encapsulates the personalized information list into a response message and sends it to the terminal via a communication protocol. The input of this step is the personalized information list and associated display metadata; the server performs data serialization and network transmission. The output of this step is a received response at the terminal containing ordered information items ready for presentation.

### Step 18

Terminal presents recommended information items to the user.

Terminal parses the received response and constructs a user interface displaying the personalized information list in a list format or in a classified format. The input of this step is the response message containing item identifiers, titles, and visual assets; the terminal executes layout calculations and rendering operations. The output of this step is a visual presentation on the display, enabling the user to view and select recommended items.

### Step 19

User performs selection operations on presented items.

User interacts with the terminal by tapping, clicking, or otherwise selecting one or more items from the personalized information list. The input of this step is the visual presentation of the personalized information list; the user generates interaction events through an input device. The output of this step is selection operation information captured by the terminal, such as selected item identifiers and action types.

### Step 20

Terminal transmits selection operation information to the server.

Terminal packages the selection operation information together with contextual data, such as timestamps and session identifiers, and sends this package to the server. The input of this step is the raw interaction events from the user interface; the terminal converts them into structured feedback data. The output of this step is a feedback request delivered to the server for logging and learning.

### Step 21

Server updates user characteristic information and learning data.

Server receives the feedback request and updates the behavior history information and evaluation information for the user. The input of this step is the selection operation information; the server performs database updates, recalculates user statistics, and may add new entries to training datasets for the machine learning model and the prompt construction module. The output of this step is an updated user profile and an expanded learning dataset that will influence future individuality evaluation values and prompt sentence generation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information recommendation systems typically rely on fixed scoring rules or static machine learning models that operate on manually engineered features. In such systems, a processor generally retrieves user preference history from a storage device, computes simple statistics such as counts or averages, and ranks items according to pre-defined formulas. These approaches suffer from several technical limitations. First, they have limited expressive power in describing complex, evolving user preferences, and therefore cannot flexibly adapt to nuanced patterns in user behavior. Second, they separate retrieval, relevance estimation, and personalization into rigidly decoupled modules, which increases data conversion overhead and constrains optimization across the entire recommendation pipeline. Third, they often require bespoke feature engineering for each domain, making it difficult to reuse infrastructure across different types of content such as images, videos, documents, or other media resources.

Recent developments in generative artificial intelligence models, including large-scale natural language processing models, offer the ability to handle complex conditional generation tasks based on natural language instructions. However, existing systems typically use such models only as auxiliary components for content generation, and do not exploit them as central engines that jointly perform search-like retrieval and personalization based on rich, dynamically constructed prompt sentences. In particular, conventional systems do not integrate (i) programmatic construction of prompt sentences that encode both user preference profiles and item attribute information, and (ii) iterative feedback of user selection results into the prompt construction process, in a tightly coupled, machine-implemented loop.

As a result, current architectures do not fully leverage the representational power of generative models to improve the underlying computer-implemented recommendation process itself. Specifically, they do not provide: (a) a structured mechanism for converting raw user history data into a preference profile via aggregation and weighting, (b) a systematic method for encoding this profile and content attributes into prompt sentences that guide a generative AI model to output a machine-parseable information set, and (c) an iterative update loop in which new selections are immediately written back to storage and used to regenerate prompts for subsequent generations. This leads to suboptimal utilization of processing resources, increased latency due to multiple disjoint components, and reduced accuracy of the information set presented to the user.

Therefore, there is a need for an improved computer-implemented technique in which a processor programmatically analyzes user preference history, automatically constructs prompt sentences tailored to a generative AI model, obtains candidate information sets from the model in a format suitable for machine parsing, and iteratively updates user preference profiles based on user selections. By tightly integrating these functions, the system can technically improve the way the computer processes recommendation tasks, reduce the complexity of separate ranking pipelines, and provide more accurate and adaptive information sets using a unified generative AI framework.

The specific processing by the specific processing unit 290 of the data processing device 12 in Example 2 is realized by the following means.

The present invention provides a server comprising a processor and a storage device, the processor being configured to acquire, based on identification information of a user, preference history data of the user stored in the storage device, to perform a feature extraction process including at least one of aggregation processing and weighting processing on the acquired preference history data to generate preference profile data representing a preference tendency of the user, to construct, in accordance with template information, prompt sentence data for input to a generative information processing model, the prompt sentence data being based on the preference profile data and attribute data of past selected items, to input the prompt sentence data to the generative information processing model and obtain candidate information set data based on generation processing performed by the generative information processing model, to analyze the candidate information set data into a predetermined data structure and format the analyzed data as information set data presentable to the user, to transmit the information set data to a terminal device via a communication device and cause a display device of the terminal device to present the information set data to the user, and to receive selection result data indicating a selection of an item in the information set data by the user from the terminal device, record the selection result data in the storage device as part of the preference history data, and reflect the recorded preference history data in generation of the prompt sentence data in a subsequent execution. This enables a computer-implemented recommendation mechanism in which the construction of prompt sentences, the invocation of a generative AI model, the parsing of generated information sets, and the iterative update of user preference profiles are integrated into a unified processing loop, thereby improving the technical performance of the information processing system by efficiently utilizing generative models for combined retrieval and personalization, reducing pipeline complexity, and adaptively generating information sets that more accurately reflect evolving user preferences.

The term “processor” refers to a hardware computation element, such as a central processing unit or a dedicated processing circuit, configured to execute instructions to perform data processing operations described in this specification.

The term “storage device” refers to a hardware memory component, such as a non-transitory semiconductor memory or a magnetic storage medium, configured to store data including preference history data, template information, and information set data.

The term “identification information of a user” refers to data that uniquely or semi-uniquely distinguishes one user from another, such as a user identifier, account identifier, or device-associated identifier, used to associate stored data with a particular user.

The term “preference history data” refers to data representing past interactions of a user with items, including but not limited to records of selected items, timestamps, and item attributes, which are stored in the storage device and used to infer the user's preference tendencies.

The term “feature extraction process” refers to processing that derives higher-level descriptive values from raw data, including operations such as aggregation, weighting, or statistical analysis, to produce feature values that characterize user preferences.

The term “aggregation processing” refers to a type of feature extraction process that combines multiple data entries, for example by counting, summing, averaging, or grouping, to produce summarized values representing patterns in the preference history data.

The term “weighting processing” refers to a type of feature extraction process that assigns different weights or importance values to individual data entries or attributes, for example based on recency or frequency, and computes weighted metrics that emphasize more relevant elements of the preference history data.

The term “preference profile data” refers to data generated from the preference history data by the feature extraction process, representing one or more inferred tendencies of a user, such as preferred categories, genres, or item attributes, in a form suitable for subsequent processing.

The term “attribute data of past selected items” refers to data describing properties of items that have been selected by the user in the past, such as categories, genres, labels, or other metadata, which are used in combination with preference profile data to construct prompt sentence data.

The term “template information” refers to pre-defined data structures, patterns, or formats, such as string templates or layout rules, that specify how elements of preference profile data and attribute data are to be composed into prompt sentence data.

The term “prompt sentence data” refers to machine-generated textual data, including one or more sentences, that encodes instructions, context, and user-related information for input to a generative information processing model in order to guide its generation behavior.

The term “generative information processing model” refers to a parameterized computational model, such as a generative artificial intelligence model based on a neural network, configured to generate output data including candidate information sets in response to input prompt sentence data.

The term “candidate information set data” refers to output data generated by the generative information processing model in response to the prompt sentence data, the output including one or more candidate items or item descriptions that are not yet fully structured for presentation to the user.

The term “predetermined data structure” refers to a pre-defined format or schema, such as a list, dictionary, or record structure, specifying how data elements within the candidate information set data are organized for efficient processing and presentation.

The term “information set data” refers to data representing a collection of one or more items, each with associated attributes or descriptions, that has been structured and formatted into the predetermined data structure for presentation to the user.

The term “communication device” refers to a hardware and software combination, such as a network interface and communication protocol stack, configured to transmit and receive data between the server and one or more terminal devices over a communication network.

The term “terminal device” refers to an end-user computing apparatus, such as a smartphone, tablet, or personal computer, configured to communicate with the server, receive information set data, and present that data to the user via a display device.

The term “display device” refers to a visual output component of a terminal device, such as a liquid crystal display or organic light-emitting diode panel, configured to visually present the information set data to the user.

The term “selection result data” refers to data indicating which item or items in the information set data have been selected by the user, including identifiers or attributes of the selected items and optionally associated timestamps or context information.

The term “visual information” refers to data representing images, video frames, or other pictorial content, from which feature value data may be extracted for use as part of the preference history data.

The term “feature value data” refers to numeric or symbolic values derived from visual information or other content, such as vector representations, category labels, or scores, that characterize the content in a form usable by the processor.

The term “composite preference profile data” refers to preference profile data that is generated based on a combination of feature value data and past preference history data, and that jointly represents multiple aspects of the user's preferences.

The term “search process” refers to a computational operation that, based on conditions expressed in the prompt sentence data, retrieves or generates items that satisfy relevance criteria with respect to user preferences or content attributes.

The term “personalization process” refers to a computational operation that adapts the selection or ranking of items to a specific user's inferred preferences, as represented by preference profile data or composite preference profile data.

The term “generation processing” refers to an internal operation performed by the generative information processing model, in which the model computes, from the prompt sentence data, output data including candidate information set data through learned transformation functions.

The term “generation request” refers to an invocation from the processor to the generative information processing model, including transmission of prompt sentence data and reception of corresponding generated output.

Server implements the invention by executing a computer program on one or more hardware computing platforms, such as a rack-mounted computer system including a multi-core central processing unit, a volatile main memory, a non-volatile storage subsystem, and a network interface controller. Server runs an operating system such as a general-purpose server operating system, and executes middleware including a web application framework (for example, a Python-based framework), a database management system (for example, a relational database), and a network communication stack implementing a transport protocol and a security protocol.

Server uses a relational database management system, such as a general-purpose relational database, as the storage device for preference history data, template information, and information set data. Server stores preference history data in a table structure with fields such as a user identifier, an item identifier, item attribute data, and a timestamp. Server stores template information in a separate table or configuration file in the storage device, where each template defines a pattern for constructing a prompt sentence by inserting fields derived from preference profile data and attribute data. Server stores information set data as records in at least one table or as structured documents in a document-oriented storage, to enable later auditing, caching, or re-use.

Server interacts with a generative AI model deployed on a separate computing infrastructure, such as a cloud-based inference service that performs neural network computations on graphics processing units or tensor processing units. Server accesses the generative AI model by transmitting prompt sentence data over a network using a representational protocol, and by receiving generated text data representing candidate information set data. The generative AI model is implemented, in one embodiment, as a transformer-based neural network including multiple encoder-decoder or decoder-only layers, multi-head attention mechanisms, and feed-forward sub-networks, trained on large-scale text corpora using gradient-based optimization.

Server constructs preference profile data by executing a feature extraction process over the preference history data. Server reads a sequence of records for a given user from the relational database, converts the records into an in-memory data structure such as an array of objects, and then calculates aggregated statistics. Server calculates, for example, counts per category, frequencies of occurrence, recency-weighted scores, and cross-category co-occurrence metrics. Server assigns higher weights to more recent selections by computing weight coefficients based on time differences between the current time and the timestamp in each record. Server multiplies frequency counts by corresponding weights, normalizes the results, and generates preference profile data as a structured object containing fields such as dominant categories, score vectors, and a textual summary describing a preference tendency.

Server uses template information to convert preference profile data and attribute data of past selected items into a prompt sentence. Server inserts, into placeholder positions of the template, expressions such as: lists of representative selected items, numerical counts, normalized scores, and textual phrases corresponding to high-scoring categories. Server thereby constructs a prompt sentence that provides the generative AI model with both contextual instructions and user-specific preference constraints. Server, in one example, constructs a prompt sentence of the following form:

“The user's past selection history is:
‘Mad Max: Fury Road’ (Action)
‘John Wick’ (Action)
‘Edge of Tomorrow’(Sci-Fi/Action)

The user strongly prefers modern, fast-paced action movies with intense fight scenes and shows moderate interest in science fiction.

Based on this history, generate a list of 10 recommended movies that the user is likely to enjoy. Output titles and short descriptions.”

Server, in another example, constructs a prompt sentence of the following form:

“The user usually selects action movies and sometimes selects science fiction movies. Please generate a list of 8 recommendations: 5 action movies and 3 sci-fi movies, all with strong pacing and visually striking scenes. For each recommendation, include a title, a genre, and a one-sentence explanation mentioning why it matches the user's past selections.”

Server transmits the prompt sentence to the generative AI model by encoding the prompt sentence in a request message and invoking an application programming interface of the generative AI model. Server specifies model parameters such as a temperature parameter controlling randomness, a maximum length parameter limiting the number of generated tokens, and a top-k or top-p parameter controlling sampling. Server provides these parameters to achieve reproducible and controllable generation behavior, which is important for stable system performance and predictable computational cost.

Server receives generated text data from the generative AI model and parses the generated text into candidate information set data. Server uses parsing rules based on the instructions embedded in the prompt sentence, such as expecting line-separated entries or a specific textual pattern. Server applies text segmentation algorithms, regular expression matching, and tokenization to identify boundaries between individual recommendations and to extract fields such as titles, genres, and explanations. Server then converts each extracted entry into a record within a predetermined data structure, such as an array of objects, and verifies that each record includes required fields. Server discards or repairs malformed entries, and may apply additional post-processing, such as deduplicating items and normalizing genre labels.

Server generates information set data by formatting the parsed candidate information set data for presentation to the user. Server attaches identifiers to each recommendation record, associates metadata such as rankings or confidence scores, and stores the information set data in memory and optionally in the storage device for later retrieval. Server then transmits the information set data to a terminal device using a communication protocol such as a secure transport protocol, by sending a response message including the information set data.

Terminal is implemented as a user-facing computing apparatus such as a portable communication device or a personal computing device. Terminal includes a display device, an input device such as a touchscreen or pointing device, and a network communication interface. Terminal executes a user interface program, for example a web browser application or a native application, which receives the information set data from the server and renders the data on the display device. Terminal arranges individual recommendation items in list or grid form, displays for each item a title, a category label, and a textual explanation or description, and attaches interactive elements, such as buttons or tappable areas, to capture user selections.

User views the information set on the display device of the terminal and operates the input device to select one or more items according to personal preferences. User, for example, taps an item corresponding to an action movie title. Terminal detects the input event, identifies a corresponding item identifier from an internal data structure, and constructs selection result data including the user identifier, the item identifier, and optionally contextual information such as a timestamp or a session identifier. Terminal transmits the selection result data back to the server using a request message.

Server receives the selection result data from the terminal and records the selection in the storage device as part of the preference history data. Server inserts a new record into the relational database table, including the user identifier, the item identifier, item attributes, and the timestamp of the selection. Server may also update aggregate tables or cached data representing counts per category or other statistics to accelerate subsequent feature extraction. Server uses the updated preference history data in a subsequent execution to regenerate preference profile data and prompt sentence data, thereby closing an iterative loop in which every new selection influences future information sets.

Server, in an additional embodiment, also incorporates visual information into the preference history data. Server receives, from the terminal or from another data source, an image or video frame corresponding to a selected item. Server applies a feature extraction pipeline using a pre-trained convolutional neural network or a vision transformer to compute feature value data, such as a high-dimensional feature vector. Server stores the feature value data in association with the relevant item in the storage device. Server, during feature extraction for preference profile generation, combines the feature value data with the selection counts and timestamps, for example by aggregating feature vectors across selections or by computing centroid vectors for frequently selected categories. Server encodes characteristics of the combined feature vectors into descriptive text or into category-like labels, and inserts such descriptions into a prompt sentence. This enables the generative AI model to take into account both symbolic item attributes and learned visual characteristics when generating new items.

Server employs a transformer-based generative AI model trained using supervised learning on pairs of prompt sentences and target outputs, and optionally further fine-tuned on domain-specific data. Server, during model training or fine-tuning, uses an objective function such as cross-entropy loss between the model's predicted token distribution and the ground truth tokens. Server performs backpropagation to compute gradients of the loss with respect to model parameters, and uses an optimization algorithm such as an adaptive gradient-based optimizer to update weights. Server may apply regularization techniques such as dropout and weight decay, and may employ data augmentation techniques, such as paraphrasing prompts or varying item orders, to improve generalization. These technical details of the generative AI model enable the system to produce coherent and contextually appropriate text outputs for a wide range of prompt sentences.

Server implements the feature extraction process, prompt construction process, and parsing process using specific data structures and algorithmic flows that provide technical advantages beyond human mental processes. Server operates on large volumes of high-dimensional data, applies mathematically defined weighting schemes based on timestamps, and performs deterministic string construction and parsing operations that would be infeasible to perform manually at the same speed and scale. Server thereby improves processing efficiency by eliminating separate ranking pipelines that are typical in conventional recommendation systems, and reduces the need for domain-specific feature engineering by leveraging a general-purpose generative model guided by structured prompt sentences.

Server achieves improved technical performance in several ways. Server reduces latency by directly obtaining candidate information set data from a single generative AI model rather than invoking multiple retrieval and ranking components; server only needs to perform light-weight parsing instead of heavy re-ranking. Server improves accuracy of recommendations by incorporating fine-grained preference profile data, including temporal weighting and visual feature data, into the prompt sentence, enabling the model to generate outputs that more closely match the user's evolving preferences. Server reduces communication overhead by encoding complex preference and attribute information into a compact prompt sentence, instead of transmitting large sets of raw user data or item data to a remote service.

Server processes data in a way that is not a mere automation of human reasoning. Server executes non-trivial statistical aggregation, high-dimensional feature transformation, and neural network inference across large datasets and multiple hardware processing units. Server coordinates the data flow between components such as the relational database, the feature extraction module, the generative AI inference module, and the user interface presentation layer. Server enforces specific rules during prompt construction and parsing, for example by structurally mapping each component of the preference profile data into predetermined sentence segments and by expecting the generative AI model to respond with a defined textual layout. These rules and flows are tailored to the capabilities and limitations of the underlying hardware and software platform, and are designed to increase throughput and robustness of the overall system.

Server can be implemented in several alternative embodiments. In one embodiment, server deploys the generative AI model locally on the same physical machine or on a local cluster, using dedicated accelerators and interconnects to reduce network latency. In another embodiment, server uses a remote cloud-based generative AI service and optimizes prompt size and model parameter selection to balance accuracy and computation cost. In yet another embodiment, server maintains multiple generative AI models specialized for different content domains, and selects a particular model based on the user's dominant preferences or the context of the request.

Terminal can also vary in implementation. In one embodiment, terminal is a mobile communication device operating a web browser, which retrieves a web application from server and executes client-side scripts to render the information set and to send selection result data. In another embodiment, terminal is a dedicated application program installed on a computing device, which uses optimized local rendering and caching to reduce bandwidth usage and to support offline viewing of previously retrieved information sets.

User interacts with the system by issuing implicit or explicit requests for recommendations, by viewing information sets, and by selecting items, without needing to understand the internal operation of the generative AI model or the feature extraction algorithms. User experiences faster response times and more relevant recommendations due to the technical improvements in data processing, model utilization, and communication efficiency achieved by server and terminal.

Server thus realizes a concrete technical implementation in which a processor, a storage device, and a generative AI model cooperate to generate, refine, and present information sets based on dynamic preference profiles and structured prompt sentences. Server's specific internal data structures, algorithms, and control flows provide measurable improvements in processing speed, accuracy of recommendations, utilization of hardware resources, and robustness of the system, thereby implementing the claimed invention in a manner that is tied to particular machines and that improves the functioning of the computer system itself.

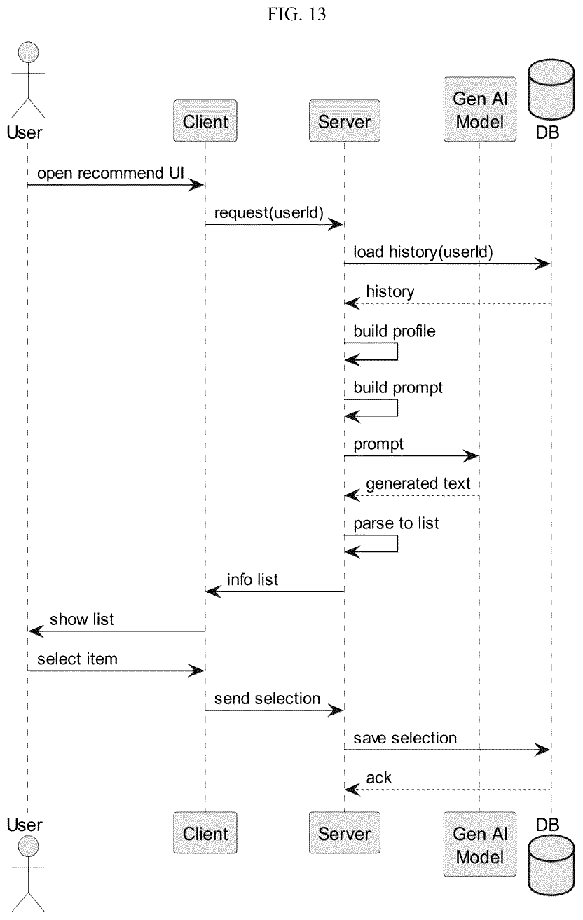

The following describes the processing flow using FIG. 13.

### Step 1

Server receives a recommendation request from terminal.

Server takes as input a request message including at least a user identifier and a content context (for example, “movies” or “books”). Server parses the request, validates the user identifier, and extracts control parameters such as a desired number of recommendations. Server outputs a normalized request object in memory, which is used as the basis for subsequent data retrieval and processing.

### Step 2

Server retrieves preference history data from a storage device.

Server takes as input the normalized request object including the user identifier. Server issues a database query (for example, an SQL query) to a relational database management system and reads records representing past selections by the identified user. Server performs data filtering to remove invalid or duplicate records and converts the query result into an in-memory list or array of preference history entries. Server outputs cleaned preference history data for the user.

### Step 3

Server performs feature extraction on the preference history data to generate preference profile data.

Server takes as input the cleaned preference history data. Server executes aggregation processing by counting the number of selections per category or attribute, computing selection frequencies, and grouping items by relevant attributes. Server executes weighting processing by assigning higher weights to more recent selections, for example by computing a time-based decay factor for each record, multiplying counts by the corresponding weights, and normalizing the results. Server calculates a score vector or set of numerical indicators representing the user's preference tendency and also derives symbolic labels such as “dominant categories” based on threshold conditions applied to the scores. Server outputs preference profile data that includes both numerical preference indicators and symbolic preference descriptors.

### Step 4

Server acquires attribute data of past selected items and combines it with the preference profile data.

Server takes as input the preference profile data and identifiers of items present in the preference history data. Server queries the storage device or a metadata service to obtain attribute data such as category labels, genres, tags, release years, or other descriptors for those items. Server merges the attribute data with the preference profile data by aligning item identifiers and attaching attributes to the corresponding entries. Server may select a subset of representative past items based on scores, recency, or diversity criteria. Server outputs combined profile-and-attribute data including representative item lists and associated attributes used for prompt construction.

### Step 5

Server constructs a prompt sentence for the generative AI model using template information.

Server takes as input the combined profile-and-attribute data and template information stored in the storage device. Server selects a template based on the content context and desired output format, and then replaces template placeholders with concrete values such as item titles, category names, numerical counts, and textual summaries of the user's preferences. Server joins sentence fragments and inserts control instructions that specify the number of recommendations and the required output format (for example, “Output titles and short descriptions.”). Server thereby performs string concatenation, placeholder substitution, and formatting operations to create a coherent natural language instruction. Server outputs a prompt sentence as a text string.

### Step 6

Server transmits the prompt sentence to the generative AI model and requests generation.

Server takes as input the prompt sentence and generation parameters such as temperature, maximum token length, and sampling parameters. Server constructs a request message that includes the prompt sentence and the parameters, and sends this message to the generative AI model via an application programming interface over a communication network. Server waits for the response while managing timeouts and error handling. Server outputs a received generated text, which represents candidate information set data produced by the generative AI model.

### Step 7

Server parses the generated text into candidate information set data.

Server takes as input the generated text from the generative AI model. Server applies parsing rules that correspond to the instructions given in the prompt sentence, such as splitting the text at line breaks to separate individual recommendations, using pattern matching to identify titles, categories, and explanations, and trimming extraneous characters. Server constructs a structured in-memory representation, for example an array of objects where each object contains at least a title, a category label, and a description. Server performs validation to ensure that each entry has the required fields and may discard or correct malformed entries. Server outputs candidate information set data in a predetermined data structure.

### Step 8

Server formats the candidate information set data into information set data ready for presentation.

Server takes as input the candidate information set data. Server assigns internal identifiers to each item, attaches ranking scores or metadata such as generation time, and may perform additional operations such as removing duplicate items and normalizing category names according to system-wide taxonomies. Server may limit the number of items according to the requested count and may sort the items by a computed relevance score or by the order provided by the generative AI model. Server outputs information set data, which is a finalized structured collection of items suitable for presentation to the user.

### Step 9

Server transmits the information set data to terminal for display.

Server takes as input the finalized information set data and the normalized request object. Server encapsulates the information set data in a response message and sends the response message to terminal via a communication device using a network transport protocol. Server may also log the transmitted information set data for monitoring and diagnostic purposes. Server outputs the response on the network, which terminal receives as input for user interface rendering.

### Step 10

Terminal renders the information set data on a display device.

Terminal takes as input the response message from server containing the information set data. Terminal parses the message and generates visual user interface components such as lists or grids, where each item is rendered with a title, a category label, and a description. Terminal binds interactive elements, such as buttons or clickable regions, to each item so that user actions can be detected. Terminal may apply style rules and layout logic to optimize readability and responsiveness on the display device. Terminal outputs a rendered screen that visually presents the information set to user.

### Step 11

User selects one or more items from the presented information set.

User takes as input the visual representation of the information set shown on the terminal display. User operates an input device such as a touchscreen or pointing device to select an item of interest, for example by tapping or clicking on the item or on an associated button. User produces a selection action as the output, which terminal captures as an input event.

### Step 12

Terminal generates selection result data and sends it to server.

Terminal takes as input the captured user selection event and the internal representation of the information set data, including item identifiers. Terminal constructs selection result data that includes at least the user identifier, the identifier of the selected item, and a timestamp or session identifier. Terminal packages this data into a request message and transmits the message to server using a network protocol. Terminal outputs the selection result data to server as part of the request.

### Step 13

Server records the selection result data as updated preference history data.

Server takes as input the selection result data received from terminal. Server validates the data, extracts fields such as the user identifier and the selected item identifier, and constructs a new preference history record. Server issues a write operation to the relational database, inserting the new record into the preference history table and committing the transaction to ensure persistence. Server may update cached aggregates or counters maintained in memory to accelerate future feature extraction. Server outputs updated preference history data that incorporates the newly recorded selection.

### Step 14

Server updates preference profile data for subsequent executions.

Server takes as input the updated preference history data and any in-memory caches of previous preference profiles. Server either recomputes the feature extraction process from the full history or incrementally updates the existing preference profile by adjusting counts, weights, and score vectors to account for the new selection. Server then stores the updated preference profile data in memory or in the storage device. Server outputs refreshed preference profile data, which will serve as input for constructing a new prompt sentence in a subsequent recommendation cycle.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional recommendation and retrieval systems typically rely on manually engineered scoring rules or fixed machine learning models that operate directly on low-level input data such as images, videos, or simple user profiles. These systems often generate results based only on static similarity metrics or pre-computed embeddings, and they do not flexibly incorporate rich contextual information such as a user's current state, evolving preferences, or high-level semantics extracted from multimedia content. As a result, the systems frequently produce recommendations or information lists that are weakly related to the user's actual intent or situation, thereby degrading user experience and wasting computational and network resources by delivering low-value content.

In particular, when images or videos are used as input, existing systems generally treat extracted visual features as direct inputs to ranking models or search queries, without exploiting higher-order reasoning over such features. They do not systematically transform the visual features and dynamic user information into expressive natural-language queries that can drive a generative AI model. Consequently, existing architectures cannot fully leverage the generative AI model's ability to synthesize, filter, and contextualize candidate items across heterogeneous information sources.

Furthermore, many systems store user selection history only as a passive log and do not feed this history back into the query generation pipeline in a fine-grained and continuous manner. This lack of feedback causes the recommendation behavior to remain static, even when the user's taste or behavioral patterns evolve. The systems therefore fail to adaptively refine both the internal preference representation and the instructions given to the generative AI model, which limits personalization accuracy and increases the amount of irrelevant content that must be transmitted, processed, and rendered.

Accordingly, there is a need for a computer-implemented technique that (i) extracts feature information from image or video data, (ii) automatically generates, based on such feature information and on user state or preference information, a prompt sentence tailored for a generative AI model, (iii) uses the generative AI model to generate and refine an information set or content set, and (iv) dynamically updates and reuses user selection history to adapt the prompt sentence and resulting information list. Such a technique should improve the operation of the underlying computing system itself by more effectively utilizing processor and network resources to produce highly relevant, individualized information lists, rather than merely automating a human mental process.

The specific processing by the specific processing unit 290 of the data processing device 12 in Application Example 2 is realized by the following means.

The present invention provides a server comprising a processor configured to extract feature information from image information supplied by a user terminal, to generate a prompt sentence for input to a generative AI model based on the extracted feature information and on state information or preference information of a user, to input the prompt sentence to the generative AI model so as to cause the generative AI model to generate an information set or a content set and to generate, from the information set or the content set, a relevance-based information list, to acquire items included in the relevance-based information list from an external information providing device or an external information providing service, to transmit the acquired items to the user terminal for presentation, to store selection history of the user received from the user terminal, to learn and update the preference information or weighting information of the user based on the stored selection history of the user, and to reflect the updated preference information or weighting information in subsequent prompt sentences automatically generated by the processor. This enables the computing system to automatically reformulate and refine queries to the generative AI model in accordance with both visual features and continuously updated user behavior, thereby improving the relevance and personalization of generated information lists, reducing unnecessary data processing and transmission, and enhancing overall computer system efficiency and technical performance.

The term “processor” refers to a hardware or virtual processing unit configured to execute instructions of a program, including a central processing unit, a graphics processing unit, or another computing element capable of performing arithmetic and logical operations.

The term “image information” refers to digital data representing still or moving visual content, including but not limited to photographs, video frames, and other rasterized visual data structures.

The term “feature information” refers to data derived from image information that characterize visual properties of the image information, including but not limited to color distributions, shapes, textures, detected objects, or semantic labels.

The term “state information” refers to information indicating a current or recent condition associated with a user, including but not limited to emotional state, contextual situation, usage environment, or temporal context.

The term “preference information” refers to information representing a tendency or inclination of a user to select, view, or interact with certain types of content, categories, or attributes over others.

The term “weighting information” refers to numerical or symbolic values assigned to one or more attributes, categories, or items to indicate relative importance, relevance, or preference strength for a user.

The term “prompt sentence” refers to a natural-language or structured textual instruction prepared for input to a generative AI model in order to specify a desired processing objective, output content, or output format.

The term “generative AI model” refers to a machine-implemented model that receives an input sequence such as a prompt sentence and generates new output information, including but not limited to text, lists, or structured data, based on learned statistical relationships.

The term “information set” refers to a collection of one or more information elements generated or identified based on processing performed by a generative AI model, a search process, or a combination thereof.

The term “content set” refers to a collection of one or more content elements, such as products, media items, or digital resources, that are generated, suggested, or selected based on output of a generative AI model.

The term “relevance-based information list” refers to an ordered or filtered list of information elements or content elements that are selected and arranged according to a relevance criterion derived from the prompt sentence, the user information, or the output of a generative AI model.

The term “external information providing device” refers to a computing apparatus or service endpoint that supplies information or content items to the server over a communication network.

The term “external information providing service” refers to a network-accessible service that offers information or content items via an interface such as an application programming interface.

The term “user terminal” refers to an electronic apparatus operated by a user, including but not limited to a mobile communication device, a tablet device, a desktop computer, or a display device, and configured to send and receive data to and from the server.

The term “selection history” refers to recorded data indicating past selections, operations, or interactions of a user with respect to items, lists, or user interface elements presented by the system.

The term “sentence structure” refers to an arrangement of textual components, including phrases, clauses, and tokens, that defines the content and format of a prompt sentence provided to a generative AI model.

The term “operation information” refers to data indicating user operations performed on a user interface, including but not limited to clicks, taps, scrolls, or selection actions.

The term “evaluation information” refers to data representing an assessment or feedback by a user regarding an item, a list, or content, including but not limited to ratings, likes, dislikes, or explicit review inputs.

The term “individualize” refers to the act of adapting or tailoring an information list or content output so that it corresponds to characteristics, preferences, or behavior patterns of a specific user.

In one embodiment, a server, a plurality of terminals, and one or more users cooperate to implement the claimed system. The server comprises at least one hardware processor, a main memory, a non-volatile storage device, a network interface, and optionally a graphics processing unit. The terminal comprises a display, an input device, a communication interface, and a local processor. The user operates the terminal to provide image information, state information, and interaction feedback.

The server executes an application program that is stored in the non-volatile storage device and loaded into the main memory. The application program is implemented, for example, as a server-side web application or service process running on an operating system. The server uses a database system, such as a relational database management system or a document-oriented database, to store feature information, preference information, weighting information, selection history, and generated information lists. The server uses a model execution framework, such as an inference runtime for a neural network model, to execute a generative AI model. The server, in some embodiments, further uses an image processing library including functions comparable to edge detection, color histogram computation, and object detection, and uses an HTTP client library to communicate with external information providing services.

The terminal executes a client application, such as a mobile application or a web browser executing script code, that communicates with the server over a network. The terminal displays information lists received from the server and transmits user operations as selection history. The terminal also transmits image information, state information, and evaluation information according to user actions. The user operates the terminal by touching a touch panel, clicking a pointing device, or entering text via a keyboard or microphone to provide content for processing by the server.

The server obtains image information from the terminal as digital raster data, such as red-green-blue pixel arrays or compressed video frames. The server converts the received image information into an intermediate data structure, for example, a three-dimensional tensor representing height, width, and color channels. The server applies image processing algorithms to this tensor to derive feature information. For example, the server computes a color histogram per channel, performs convolution operations to detect edges and lines, and applies a clustering algorithm to group similar color regions. The server may also run a pre-trained convolutional neural network classifier on the image information to obtain high-level semantic labels (for example, “sunset,” “beach,” “running shoes,” “sportswear”) and associated confidence scores. The server stores the obtained feature information as structured records, such as numeric vectors and keyword lists, in the database.

The server further maintains state information and preference information for each user. The server initializes preference information and weighting information as default vectors and updates them based on selection history. The server represents preference information as high-dimensional vectors whose dimensions correspond to content attributes such as category, genre, style, or other tags. The server represents weighting information as scalar values applied to each dimension of the preference vectors. By using such data structures, the server can perform efficient vector operations, such as dot products and normalization, to quantify the relevance of content attributes to a particular user.

The server uses a generative AI model that is implemented as a neural network comprising an embedding layer, a plurality of self-attention layers, feed-forward layers, and an output layer. The generative AI model is trained in advance using unsupervised or semi-supervised learning on large corpora of natural-language text. During training, the generative AI model minimizes a loss function such as cross-entropy between predicted tokens and ground-truth tokens, updating weight parameters using gradient descent or a variant thereof. The server stores the trained weight parameters of the generative AI model in the non-volatile storage device and loads them into memory when executing inference.

The server constructs a prompt sentence as input to the generative AI model by combining feature information, state information, and preference or weighting information. The server uses a sentence template or rule set to convert structured data into textual instructions. For example, the server can generate a prompt sentence such as:

“The user frequently selects running shoes and sportswear. The latest uploaded photo shows a sunset at the beach with dominant orange and blue colors, and the user's current mood is calm. Using this context, generate a personalized list of 15 products including running shoes, sportswear, and related accessories. For each item, provide a short marketing description. Output the result as numbered plain text.”

The server may in another example generate a prompt sentence such as:

“This image shows a calm sunset over the sea. Detected keywords: ‘sunset’, ‘orange sky’, ‘sea’. The user's emotion is nostalgic. Generate 10 songs and 5 movies that fit a nostalgic, calm beach sunset mood. Return the results as a list with each item preceded by a number and including a short reason.”

The server may also generate a prompt sentence such as:

“The user has repeatedly selected running shoes and sportswear, and the latest emotion is motivated. Generate a ranked list of 20 items that support an active running lifestyle, including shoes, apparel, and accessories. Provide one short explanation for why each item matches the user's preferences.”

The server does not merely relay user input to the generative AI model. Instead, the server transforms low-level image features and quantitative preference vectors into a non-conventional prompt sentence structure designed to control the generative AI model. The server explicitly encodes relevance weights and dominant attributes in the prompt sentence, which alters the generative AI model's attention pattern and output distribution. This transformation constitutes a technical data processing operation that is specifically adapted to the architecture of the generative AI model and is not equivalent to simply forwarding user text.

The server executes the generative AI model by providing the prompt sentence as input token sequences. The server converts the characters or words of the prompt sentence into embedding vectors using a pre-defined tokenization and embedding matrix. The generative AI model processes the embeddings through multiple self-attention layers, computing attention weights between tokens and aggregating contextual information. The model computes probability distributions over possible next tokens at each output position. The server samples or selects tokens according to these distributions, for example using a beam search or top-k sampling algorithm, to obtain an output text sequence representing an information set or content set. The server stores the output text and associates it with the corresponding prompt sentence and user identifier.

The server then post-processes the output text to generate a relevance-based information list. The server parses the output text using pattern matching or a secondary lightweight parsing model to extract individual item titles, categories, reasons, or other attributes. The server uses these attributes as search queries against one or more external information providing services. For instance, when the output text describes a song title or a product description, the server formulates an application programming interface request containing the title and associated tags and sends it to an external service. The server receives structured item data, such as unique identifiers, availability, price, and metadata, from the external service.

The server computes relevance scores for the retrieved items by combining the generative AI model's implicit ranking with explicit preference or weighting information. The server can, for example, calculate a relevance score as a weighted sum of matching attributes, where the weights are derived from the user's preference vector and the item's attribute vector. The server then sorts the items by relevance score to form the relevance-based information list. The server may also eliminate items that do not meet predefined technical constraints, such as being unavailable in the user's region or exceeding a storage size limit, thereby reducing network traffic and computational overhead for subsequent processing.

The server transmits the final relevance-based information list to the terminal over the network. The server formats the data into a compact representation, such as a minimized structured document, to reduce communication load. The terminal receives the relevance-based information list and renders the items as graphical user interface components. The terminal may, for example, display items as cards with images, names, and descriptions, or provide playback controls for media content. The user views the list and interacts with it by scrolling, selecting items, and providing evaluation information such as likes or ratings.

The terminal records user operations and transmits selection history and evaluation information back to the server. The server stores each new interaction as a time-stamped event record. The server updates the preference information and weighting information by applying a learning algorithm. In one embodiment, the server uses a matrix factorization model or a neural network-based recommender model. The server defines a loss function that measures the discrepancy between predicted user preference scores and observed user selections. The server updates the parameters of the preference model by stochastic gradient descent or another optimization method. The server may also use online learning techniques, updating preference vectors incrementally as new data arrive, which improves responsiveness to changing user behavior.

The server then modifies subsequent prompt sentences to reflect the updated preference information and weighting information. For example, when the user repeatedly selects content tagged as “running” and “outdoor,” the server increases the corresponding weighting values and incorporates this change into the textual description in the prompt sentence. The server may generate a prompt sentence such as:

“Based on the user's updated preference profile, the user has a strong preference for running and outdoor activities and a moderate preference for casual wear. Generate 15 recommended items focused on running and outdoor use, including shoes, apparel, and accessories, with short justifications for each recommendation.”

By explicitly encoding learned preference changes into the prompt sentence, the server alters the generative AI model's behavior in a way that a human user could not feasibly replicate manually at the same speed or scale. The server uses a non-conventional feedback loop in which selection history drives modification of both internal numeric models and external natural-language instructions. This loop enables the computing system to adapt its text-based query formulation and item selection logic dynamically, achieving improved prediction accuracy and reduced irrelevant output compared to static rule-based systems.

The server architecture and described data processing provide technical advantages. Because the server uses concise feature vectors and preference vectors to guide prompt sentence generation, the amount of raw multimedia data transmitted to the generative AI model is minimized. As a result, the system reduces bandwidth usage and inference time. The server also performs early filtering and ranking of items using numeric relevance scores before sending data to the terminal, thereby reducing the size of the transmitted lists and lowering rendering load on the terminal. Further, by consolidating selection history in structured formats and updating preference models incrementally, the server avoids full retraining from scratch and achieves faster adaptation with lower computational cost.

The system improves the functioning of the computing environment in several respects. The server transforms low-level pixel data and high-volume interaction logs into compact and semantically rich prompt sentences that are optimized for a generative AI model architecture. This internal representation change allows the generative AI model to operate more effectively, increasing the precision of generated suggestions. The server thereby reduces the number of iterations required to obtain satisfactory content, which directly decreases processor utilization and network requests. The server's use of learned preference vectors and weighting information allows more accurate control of the generative AI model, decreasing errors in relevance ranking and improving the technical performance of the recommendation process.

In alternative embodiments, the server may use different generative AI model structures, such as encoder-decoder architectures, recurrent network architectures, or mixtures thereof. The server may also use different feature extractors, for instance, vision transformers instead of convolutional neural networks, and may store feature information in a feature store optimized for vector similarity search. The preference learning algorithm may be implemented as a gradient-boosted decision tree model, a factorization machine, or another machine learning model. The essential aspect is that the server uses quantitatively learned preference and weighting information to systematically generate and update prompt sentences and then uses the generative AI model's output together with numeric relevance computation to construct a relevance-based information list.

In another embodiment, the server may handle multiple content domains simultaneously, such as products, multimedia entertainment, and informative articles. The server may encode domain information into the prompt sentence and may use domain-specific external information providing services to retrieve final items. For example, the server may construct a prompt sentence that explicitly requests a mixture of products, songs, and videos tailored to a specified mood and context, and then apply distinct mapping logics for each domain. The server still uses a common preference and weighting framework to prioritize items across domains, thus achieving a unified and technically efficient personalization mechanism.

In this way, the system does not merely automate a human mental process of choosing items. Instead, the system introduces specific data structures, algorithmic steps, and model interactions that improve how the computing system processes, combines, and distributes information. The cooperation between visual feature extraction, learned preference modeling, structured prompt sentence generation, generative AI inference, and relevance-based list construction yields measurable improvements in recommendation accuracy, computation efficiency, and bandwidth utilization, thereby demonstrating a concrete technical effect in the operation of the computer system.

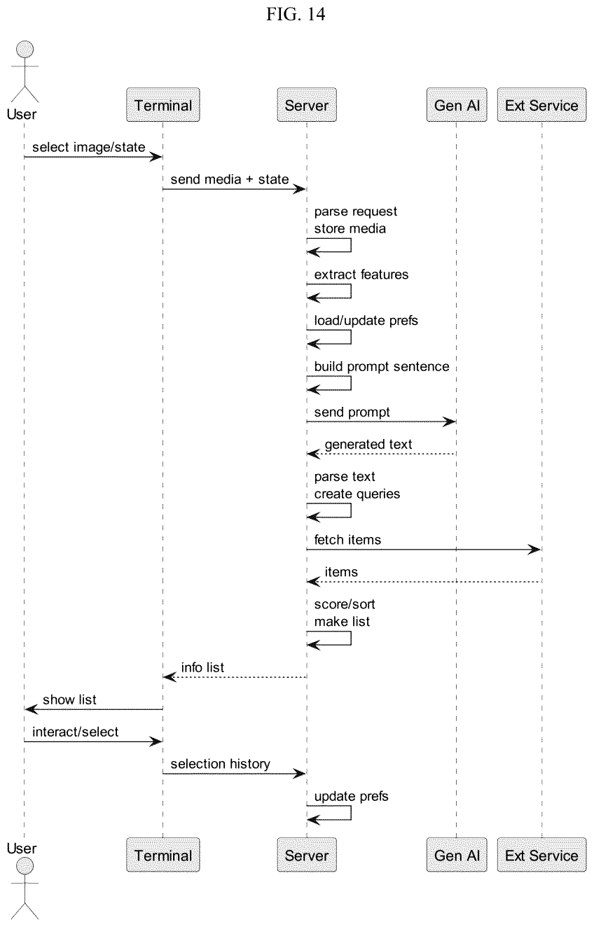

The following describes the processing flow using FIG. 14.

### Step 1

User operates the terminal to provide image information and state information.

User selects one or more images or videos stored in local storage, or captures new images or videos via a built-in camera, and optionally inputs mood or preference text (for example, “relaxed,” “I want running items”). The input in this step is raw media data and user-entered text. The output of this step is a request payload prepared by the terminal that contains the media files, associated metadata (resolution, capture time), and state information or preference text.

### Step 2

Terminal transmits the request payload to the server.

Terminal packages the selected media files and state information into a structured format, such as multipart/form-data containing a JSON section and one or more binary sections. The input in this step is the media data and state information prepared in Step 1. The terminal performs data encapsulation and protocol operations to create an HTTP(S) request and sends it to a predefined server endpoint. The output of this step is the transmitted network request containing the payload.

### Step 3

Server receives and parses the request payload.

Server, via a network interface, accepts the incoming HTTP(S) request from the terminal and validates headers, authentication tokens, and payload size. The input in this step is the raw HTTP(S) request. The server decodes the multipart/form-data, separates the JSON segment from the binary media segments, and stores temporary copies in memory and non-volatile storage. The server extracts user identifiers, timestamps, and state information from the JSON. The output of this step is structured in-memory objects for image information, state information, and user metadata.

### Step 4

Server extracts feature information from the image information.

Server converts the image or video frame data into standard tensors (for example, height ×width ×channel arrays) and applies image processing operations using an image processing library. The input in this step is the decoded image tensor. The server computes color histograms, applies edge detection filters, and may run a convolutional neural network classifier to obtain high-level labels and confidence scores. The server then aggregates these low-level and high-level descriptors into a feature vector and a keyword list. The output of this step is feature information representing visual characteristics and semantic tags for the input media.

### Step 5

Server retrieves and updates user preference information and weighting information.

Server queries a user profile database using the user identifier to obtain stored preference vectors and weighting values. The input in this step is the user identifier and existing profile data. The server adjusts the preference vectors based on the new state information (for example, weighting “relaxed” or “motivated” moods) and any recently recorded selection history events. The server uses arithmetic operations such as weighted averaging or incremental gradient updates to modify preference and weighting values. The output of this step is an updated preference information vector and associated weighting information for the user.

### Step 6

Server constructs a prompt sentence for the generative AI model.

Server combines the feature information, state information, and updated preference or weighting information into a structured textual instruction. The input in this step is the feature vector, keyword list, state label, and preference vector. The server applies a rule-based text generation routine or template system, inserting the dominant keywords, mood terms, and preferred categories into a natural-language description. The server also appends explicit constraints on list length, output format, and item types. The output of this step is a prompt sentence such as:

“The user frequently selects running shoes and sportswear. The latest uploaded photo shows a sunset at the beach with dominant orange and blue colors, and the user's current mood is calm. Using this context, generate a personalized list of 15 products including running shoes, sportswear, and related accessories. For each item, provide a short marketing description. Output the result as numbered plain text.”

### Step 7

Server executes the generative AI model using the prompt sentence.

Server tokenizes the prompt sentence into tokens and converts the tokens into embedding vectors using a tokenization and embedding mechanism associated with the generative AI model. The input in this step is the prompt sentence text. The server feeds the sequence of embeddings into the generative AI model, which processes the embeddings through multiple self-attention layers and feed-forward layers to compute probability distributions over output tokens. The server then applies a decoding algorithm, such as beam search or top-k sampling, to generate an output token sequence. The output of this step is an output text that describes an information set or content set, for example a numbered list of items with textual descriptions.

### Step 8

Server parses the output text and maps it to concrete items.

Server analyzes the generated text using pattern matching, regular expressions, or a lightweight parsing model to extract item titles, categories, and optional reasons or tags. The input in this step is the raw output text from the generative AI model. The server splits the text into lines, identifies line numbers, and separates item names from explanations by detecting delimiters. The server then uses the extracted titles and tags as query parameters to content databases or external information providing services via their interfaces. The output of this step is a set of candidate concrete items, each associated with metadata such as identifiers, category labels, availability, and other attributes.

### Step 9

Server computes relevance scores and generates a relevance-based information list.

Server, for each candidate item, retrieves corresponding attribute vectors (for example, category embeddings, tags) from a local database and combines them with the user's preference and weighting vectors. The input in this step is the set of candidate items and the updated preference and weighting information. The server calculates a relevance score for each item, for example by computing a dot product between the item attribute vector and the user preference vector, adjusted by weighting factors. The server then sorts the items in descending order of relevance score and optionally filters out items that do not satisfy predefined constraints such as stock status or region compatibility. The output of this step is a relevance-based information list, represented as an ordered collection of item records.

### Step 10

Server transmits the relevance-based information list to the terminal.

Server serializes the ordered item records into a compact structured document and sends this document to the terminal over HTTP(S) as a response to a recommendation request. The input in this step is the relevance-based information list generated in Step 9. The server may compress the document or remove nonessential fields to reduce bandwidth. The output of this step is the network response containing the final personalized list.

### Step 11

Terminal renders the relevance-based information list and collects user interactions.

Terminal receives the structured document from the server and parses it into internal data structures suitable for user interface rendering. The input in this step is the serialized information list from the server. The terminal creates graphical elements (for example, cards, rows, thumbnails) for each item and displays them on a display unit in the order specified. The user then browses the list and performs operations such as selecting items, scrolling, or applying ratings. The output of this step is a set of interaction events captured locally by the terminal.

### Step 12

Terminal sends selection history and evaluation information back to the server.

Terminal groups recorded interaction events into selection history entries, each containing a user identifier, item identifier, action type (click, view, like, skip), timestamp, and optional evaluation value. The input in this step is the raw interaction events from Step 11. The terminal formats these entries as structured records and transmits them to the server using an HTTP(S) request. The output of this step is a transmitted batch of selection history and evaluation information.

### Step 13

Server updates selection history, preference information, and future prompt sentences.

Server receives the batch of selection history from the terminal and writes it into a selection history database, associating each record with the corresponding user and item. The input in this step is the structured selection history entries. The server then applies a learning algorithm that uses these entries to adjust the user's preference and weighting vectors, for example increasing weights for frequently selected categories and decreasing weights for consistently ignored categories. The server computes updated vectors by applying numerical operations such as gradient steps or exponential moving averages. The output of this step is an updated selection history store and new preference and weighting information, which the server will incorporate into subsequent prompt sentences in Step 6, thereby closing the feedback loop and continuously refining the behavior of the generative AI model for that user.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

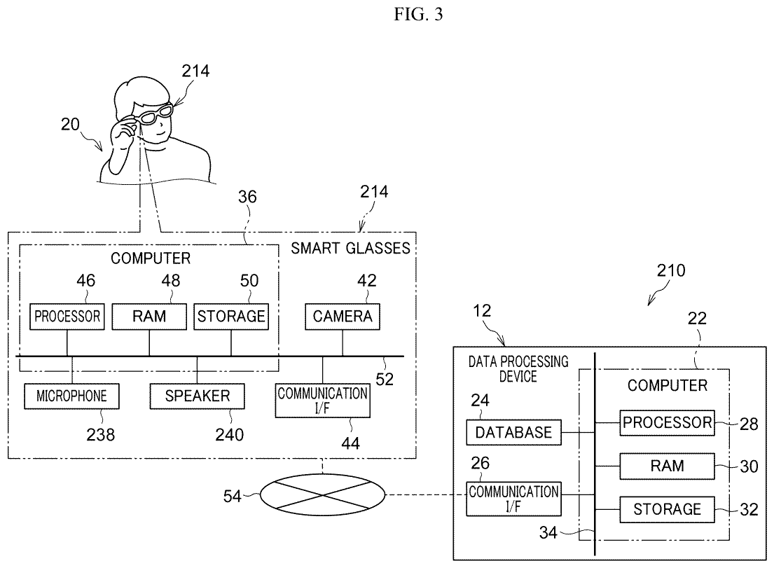

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

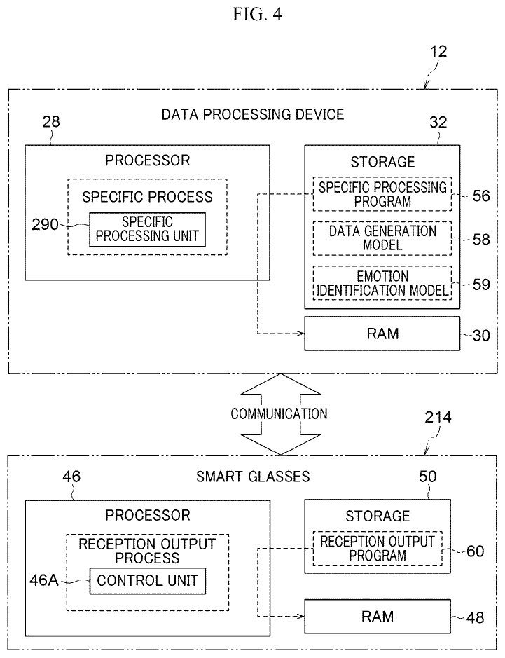

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

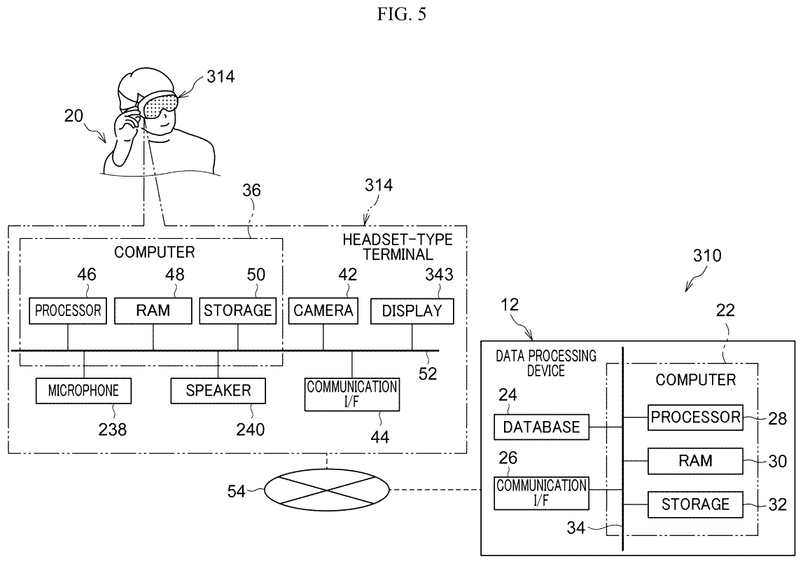

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

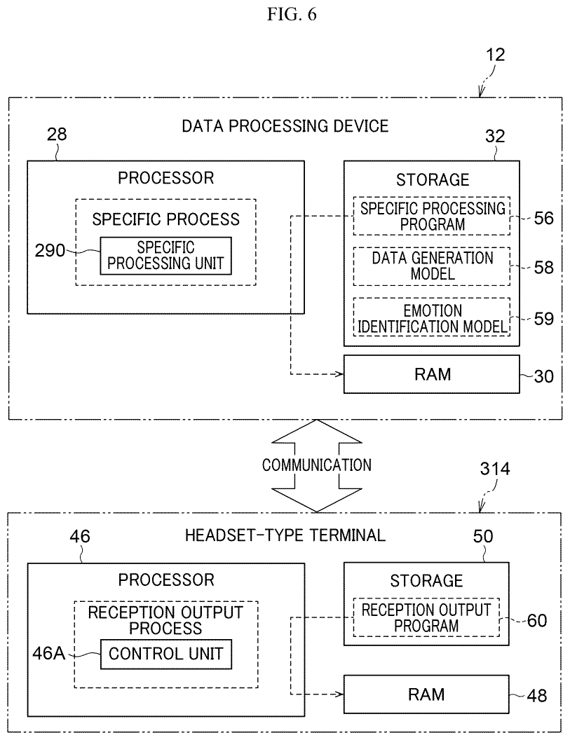

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

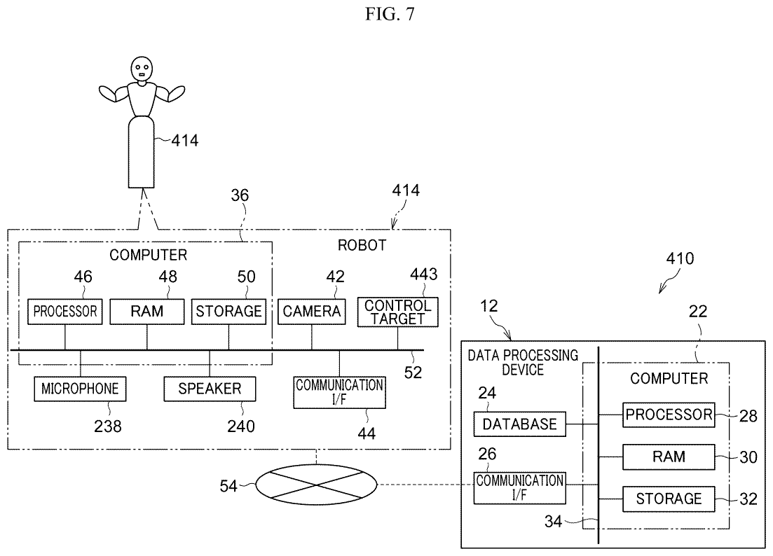

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

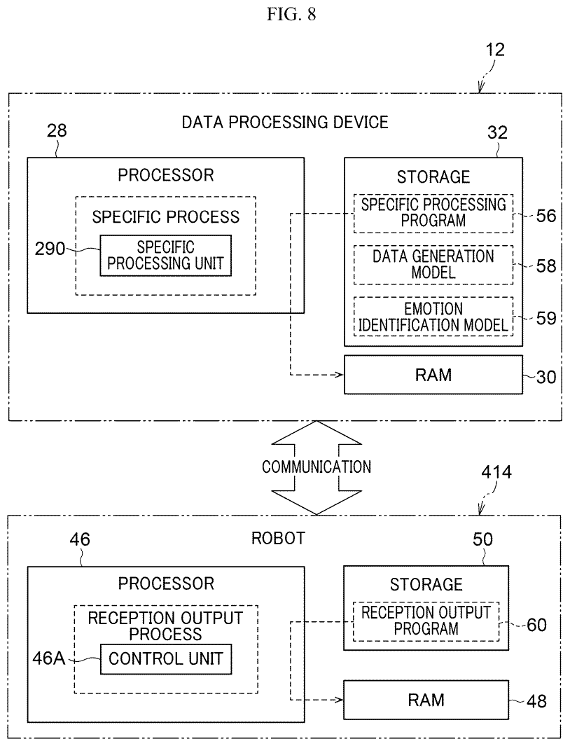

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

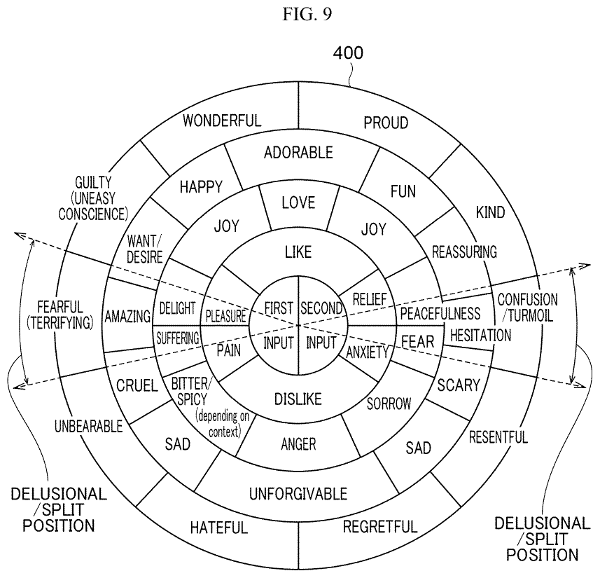

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

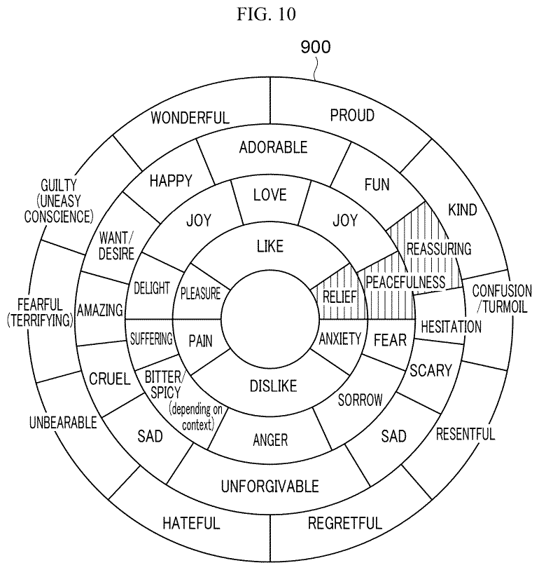

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive media information transmitted from a terminal that acquires visual information, the media information including image information or video information obtained in daily life of a user,
convert the media information into analysis data and extract, as numerical data, visual feature quantities including color information, shape information, texture information, and motion information on the basis of the analysis data,
generate a search request that uses the visual feature quantities as feature vectors for similarity search and that is used to compare the visual feature vectors with feature vectors of content registered in an information collection, and acquire a candidate content set from the information collection by using an information retrieval apparatus on the basis of the search request,
construct a prompt sentence for generation of a high-relevance information list on the basis of the candidate content set and the visual feature quantities, input the prompt sentence and the candidate content set into a generative artificial intelligence model, and cause the generative artificial intelligence model to perform ranking or filtering of the candidate content set so as to generate the high-relevance information list,
format the high-relevance information list into output data for transmission to the terminal, and cause the terminal to present the high-relevance information list in a form viewable by the user, and
store, as record information, the prompt sentence and information relating to the candidate content set that are used for generation of the high-relevance information list.

### Supplementary 2

The system according to supplementary 1,
wherein the processor is configured to
acquire history information related to the user, calculate attribute information representing a preference tendency of the user on the basis of the history information, and dynamically generate the prompt sentence to be input to the generative artificial intelligence model on the basis of the attribute information, the visual feature quantities, and the candidate content set, thereby customizing the high-relevance information list for each user.

### Supplementary 3

The system according to supplementary 1,
wherein the processor is configured to
add explanation information output from the generative artificial intelligence model to each content included in the high-relevance information list, generate display data including the explanation information, present the display data via a user interface, acquire operation information relating to selection operations or browsing operations of the user on the user interface, and accumulate the operation information as the history information.

### Application Example 1

### Supplementary 1

A system comprising a processor,
wherein the processor is configured to
extract visual feature information included in acquired still image information or moving image information by using an analysis unit,
generate a prompt sentence for searching an information set for related information items, the prompt sentence being generated on the basis of the extracted visual feature information and on the basis of scene information or affective information estimated from the still image information or the moving image information,
search the information set by using a generative information processing model on the basis of the prompt sentence and the visual feature information, and generate a relevance information list including candidate information items related to content of the still image information or the moving image information,
calculate, for each information item included in the relevance information list, a similarity degree between the visual feature information and a pre-calculated feature representation of each information item, and update the relevance information list on the basis of the similarity degree,
generate a personalized information list by inputting user characteristic information including behavior history information or evaluation information of a user into a machine learning model as input feature information with respect to the relevance information list, calculating an individuality evaluation value for each information item by using the machine learning model, and ranking the relevance information list on the basis of the individuality evaluation value, and
store generation histories of the prompt sentence and the personalized information list, and update generation conditions of the prompt sentence on the basis of an accumulation result of the generation histories.

### Supplementary 2

The system according to supplementary 1,
wherein the processor is configured to adjust, for each user, the prompt sentence input to the generative information processing model by adding or modifying, on the basis of the behavior history information or the evaluation information of the user, a description representing a desired information type, an expression style, a number of items, or preference conditions in the prompt sentence, and to cause the generative information processing model to generate the personalized information list by using the adjusted prompt sentence.

### Supplementary 3

The system according to supplementary 1,
wherein the processor is configured to cause the personalized information list to be presented, via a display control unit operating on a user terminal, in a list format or a classified format associated with the still image information or the moving image information, and further to supply selection operation information of the user with respect to the presentation as the user characteristic information to the machine learning model as learning data.

### Example 2

### Supplementary 1

A system comprising a processor and a storage device,
wherein the processor is configured to
acquire, based on identification information of a user, preference history data of the user stored in the storage device,
perform a feature extraction process including at least one of aggregation processing and weighting processing on the acquired preference history data to generate preference profile data representing a preference tendency of the user,
construct, in accordance with template information, prompt sentence data for input to a generative information processing model, the prompt sentence data being based on the preference profile data and attribute data of past selected items,
input the prompt sentence data to the generative information processing model and obtain candidate information set data based on generation processing performed by the generative information processing model,
analyze the candidate information set data into a predetermined data structure and format the analyzed data as information set data presentable to the user,
transmit the information set data to a terminal device via a communication device and cause a display device of the terminal device to present the information set data to the user, and
receive selection result data indicating a selection of an item in the information set data by the user from the terminal device, record the selection result data in the storage device as part of the preference history data, and reflect the recorded preference history data in generation of the prompt sentence data in a subsequent execution.

### Supplementary 2

The system according to supplementary 1,
wherein the processor is configured to
acquire, as the preference history data, both feature value data extracted from visual information and past preference history data of the user, generate composite preference profile data based on a combination of the feature value data and the past preference history data, and generate prompt sentence data that instructs both a search process and a personalization process based on the composite preference profile data, and input the prompt sentence data to the generative information processing model so as to cause the generative information processing model to generate the information set data reflecting both relevance based on visual features and the preference tendency of the user.

### Supplementary 3

The system according to supplementary 1,
wherein the processor is configured to
regenerate the preference profile data and the prompt sentence data based on updated preference history data on condition that the selection result data has been recorded after the information set data has been presented on the terminal device, and repeatedly issue generation requests to the generative information processing model so as to provide, in stages, information set data that sequentially reflects changes in the preference tendency of the user.

### Application Example 2

### Supplementary 1

A system comprising a processor,
wherein the processor is configured to
extract feature information from image information, generate a prompt sentence for input to a generative AI model based on the extracted feature information and on state information or preference information of a user,
input the prompt sentence to the generative AI model to cause the generative AI model to generate an information set or a content set and to generate, from the information set or the content set, a relevance-based information list,
acquire items included in the relevance-based information list from an external information providing device or an external information providing service,
transmit the acquired items to a user terminal and cause the acquired items to be presented on the user terminal,
store selection history of the user transmitted from the user terminal,
learn and update the preference information or weighting information of the user based on the stored selection history of the user, and
reflect the updated preference information or weighting information in the prompt sentence.

### Supplementary 2

The system according to supplementary 1,
wherein the processor is configured to
automatically generate a sentence structure of the prompt sentence including the feature information, the state information of the user, and the updated preference information or weighting information, and to generate, as the relevance-based information list, a customized information list based on the updated preference information or weighting information from the information set or the content set output from the generative AI model.

### Supplementary 3

The system according to supplementary 1,
wherein the processor is configured to
acquire operation information or evaluation information of the user with respect to the relevance-based information list as the selection history of the user, and sequentially change contents of the prompt sentence input to the generative AI model using the acquired selection history so as to dynamically individualize, for each user, an information list generated by the generative AI model.

What is claimed is:

1. A system comprising:
circuitry configured to:
acquire, via a communication interface coupled to a packet-switched network, media data comprising visual frame data transmitted from a terminal device;
convert the media data into a normalized tensor representation and extract a multidimensional feature vector from the normalized tensor representation by propagating the normalized tensor representation through a neural network feature extractor;
construct a prompt data structure on the basis of the multidimensional feature vector and transmit the prompt data structure to a generative neural network model to obtain response data comprising candidate identifiers;
compute a similarity measure between the multidimensional feature vector and a stored feature representation associated with each of the candidate identifiers to generate a relevance-scored data structure;
apply a ranking model to the relevance-scored data structure to compute a ranking score for each candidate identifier and generate a ranked data structure ordered by the ranking scores; and
transmit the ranked data structure to the terminal device via the packet-switched network.

2. The system according to claim 1, wherein the circuitry is configured to convert the media data into the normalized tensor representation by decoding the visual frame data into pixel matrices, resizing the pixel matrices to a predetermined resolution, and normalizing pixel values to a predetermined numeric range, and to extract low-level feature descriptors comprising at least a color histogram computed over a selected color space, an edge descriptor derived from edge detection filtering, and a texture descriptor derived from local pattern operators.

3. The system according to claim 2, wherein the neural network feature extractor comprises a convolutional neural network including a plurality of convolutional layers, batch normalization layers, and non-linear activation layers, and wherein the circuitry is configured to remove a final classification layer of the convolutional neural network and obtain the multidimensional feature vector from an intermediate feature extraction layer as a fixed-dimensional dense vector encoding semantic properties of the media data.

4. The system according to claim 3, wherein the media data further comprises a temporal sequence of visual frames, and wherein the circuitry is configured to extract motion descriptors from inter-frame differences or motion vector histograms computed across the temporal sequence, and to concatenate the motion descriptors with the multidimensional feature vector to generate an integrated feature vector representing both spatial and temporal characteristics.

5. The system according to claim 4, wherein the circuitry is configured to apply dimensionality reduction to the integrated feature vector by projecting the integrated feature vector into a lower-dimensional subspace, and to store the reduced integrated feature vector in a feature store indexed by a media identifier for subsequent similarity retrieval.

6. The system according to claim 1, wherein the circuitry is configured to construct the prompt data structure by mapping numerical ranges of the multidimensional feature vector to qualitative descriptive labels representing visual characteristics of the media data, and assembling the qualitative descriptive labels together with metadata of the candidate identifiers into a natural language template that specifies ranking criteria and output format instructions for the generative neural network model.

7. The system according to claim 6, wherein the circuitry is configured to parse the response data received from the generative neural network model by segmenting output text into individual candidate entries using pattern matching, extracting identifiers and associated descriptive attributes from each candidate entry, and matching the extracted identifiers against records in a storage device to obtain complete metadata for each candidate identifier.

8. The system according to claim 7, wherein the circuitry is configured to store, as record information, the prompt data structure, the candidate identifiers, and the response data received from the generative neural network model, and to analyze an accumulation of the record information to update generation conditions used when constructing a subsequent prompt data structure, thereby iteratively refining the prompt construction logic on the basis of observed outcomes.

9. The system according to claim 1, wherein the circuitry is configured to acquire preference history data of a user associated with the terminal device from a storage device, perform aggregation processing and recency-based weighting processing on the preference history data to generate preference profile data representing a preference tendency of the user, and include the preference profile data in the prompt data structure transmitted to the generative neural network model.

10. The system according to claim 9, wherein the ranking model comprises a neural network including embedding layers for user feature vectors and item feature vectors, concatenation layers, and fully connected layers with non-linear activations, and wherein the circuitry is configured to compute the ranking score as an individuality evaluation value representing an estimated probability that the user will select a given candidate identifier.

11. The system according to claim 10, wherein the circuitry is configured to receive selection result data from the terminal device indicating which candidate identifiers the user selected from the ranked data structure, record the selection result data in the storage device as updated preference history data, and retrain or incrementally update parameters of the ranking model on the basis of the updated preference history data using a gradient-based optimization method with a pairwise ranking loss function.

12. The system according to claim 1, wherein the circuitry is configured to apply an emotion analysis model to data received from the terminal device to determine an emotional state of a user, and to include information representing the determined emotional state in the prompt data structure transmitted to the generative neural network model, such that the response data reflects the emotional state in selection or ordering of the candidate identifiers.

13. The system according to claim 12, wherein the emotion analysis model maps input data to a probability distribution over a plurality of emotion categories arranged on an emotion map with valence and arousal dimensions, and wherein the circuitry is configured to derive an affective label from a region of the emotion map corresponding to a highest-probability emotion category and embed the affective label as a constraint term in the prompt data structure.

14. The system according to claim 1, wherein the circuitry is configured to acquire content items corresponding to the candidate identifiers in the ranked data structure from an external information providing service via an application programming interface, and to attach metadata of the acquired content items to corresponding entries in the ranked data structure before transmitting the ranked data structure to the terminal device.

15. The system according to claim 14, wherein the content items comprise at least one of audiovisual media items, product items, and document items, and wherein the circuitry is configured to filter the content items on the basis of availability constraints and region compatibility constraints before including the content items in the ranked data structure.

16. The system according to claim 1, wherein the terminal device comprises at least one of a smart device having a display and a touch panel, smart glasses having a speaker and a microphone, a headset-type terminal having a display and a speaker, and a robot having a speaker and a motor-driven control target, and wherein the circuitry is configured to format the ranked data structure in a presentation format corresponding to an output capability of the terminal device.

17. The system according to claim 16, wherein the circuitry is configured to include, in the ranked data structure, explanation information generated by the generative neural network model indicating a reason for each candidate identifier being included in the ranked data structure, and to transmit the explanation information together with the ranked data structure to the terminal device for rendering in association with each candidate identifier.

18. A system comprising:
circuitry configured to:
acquire, via a communication interface coupled to a packet-switched network, media data comprising visual frame data including at least one of image data and video data transmitted from a terminal device;
convert the media data into a normalized tensor representation by decoding the visual frame data into pixel matrices and normalizing pixel values, and extract a multidimensional feature vector by propagating the normalized tensor representation through a convolutional neural network feature extractor comprising a plurality of convolutional layers and obtaining activations from an intermediate feature extraction layer;
construct a prompt data structure by mapping numerical ranges of the multidimensional feature vector to qualitative descriptive labels and assembling the qualitative descriptive labels with preference profile data of a user into a natural language template, and transmit the prompt data structure to a generative neural network model comprising a Transformer-based architecture that predicts output tokens via softmax probability computation to obtain response data comprising candidate identifiers with associated descriptive attributes;
compute a similarity measure between the multidimensional feature vector and a stored feature representation associated with each of the candidate identifiers using a vector similarity operation to generate a relevance-scored data structure;
apply a ranking model comprising a neural network with embedding layers and fully connected layers to the relevance-scored data structure and the preference profile data to compute an individuality evaluation value for each candidate identifier, and generate a ranked data structure ordered by the individuality evaluation values;
store, as record information, the prompt data structure, the candidate identifiers, and the response data, and update generation conditions for constructing subsequent prompt data structures on the basis of accumulated record information; and
transmit the ranked data structure to the terminal device via the packet-switched network.

19. The system according to claim 18, wherein the circuitry is configured to receive selection result data from the terminal device indicating which candidate identifiers the user selected, record the selection result data as updated preference history data, and incrementally update parameters of the ranking model using a gradient-based optimization method on the basis of the updated preference history data, and wherein the circuitry is configured to apply an emotion analysis model to data received from the terminal device to determine an emotional state and include information representing the emotional state in a subsequent prompt data structure.

20. A method performed by circuitry of a server coupled to a packet-switched network via a communication interface, the method comprising:
acquiring, via the communication interface, media data comprising visual frame data transmitted from a terminal device;
converting the media data into a normalized tensor representation and extracting a multidimensional feature vector from the normalized tensor representation by propagating the normalized tensor representation through a neural network feature extractor;
constructing a prompt data structure on the basis of the multidimensional feature vector and transmitting the prompt data structure to a generative neural network model to obtain response data comprising candidate identifiers;
computing a similarity measure between the multidimensional feature vector and a stored feature representation associated with each of the candidate identifiers to generate a relevance-scored data structure;
applying a ranking model to the relevance-scored data structure to compute a ranking score for each candidate identifier and generating a ranked data structure ordered by the ranking scores; and
transmitting the ranked data structure to the terminal device via the packet-switched network.
